(19) United States
(12) Patent Application Publication
(10) Pub. No.: US 2024/0156061 A1
(43) Pub. Date: May 16, 2024

(54) APPARATUS FOR LOCATIONAL CONTROL OF ANIMAL VOIDING AND METHOD THEREFOR

(71) Applicant: HALTER USA INC., San Francisco, CA (US)

(72) Inventors: Craig Piggott, Auckland (NZ); Daniel Hearn, Auckland (NZ); Steve Crowhurst, Auckland (NZ)

(73) Assignee: HALTER USA INC., San Francisco, CA (US)

(21) Appl. No.: 18/393,897

(22) Filed: Dec. 22, 2023

Related U.S. Application Data
(63) Continuation of application No. PCT/NZ2022/050098, filed on Jul. 18, 2022.

(30) Foreign Application Priority Data
Jul. 16, 2021 (AU) 2021104227

(51) Int. Cl. A01K 27/00; A01K 11/00; A01K 15/02; A01K 29/00

(52) U.S. Cl. CPC A01K 27/009; A01K 11/008; A01K 15/028; A01K 29/005

(57) ABSTRACT

A wearable device for moving animals in a pastoral environment from their current location to a more desirable location to defecate or urinate (void), or cueing or training an animal to void when in a desirable location. The device administers a stimulus to a bovine animal to move it away from less desirable locations such as waterways, to more desirable locations, such as areas of carbon-rich soil, areas where previous animals have not voided recently, and excreta catchment areas.

### CROSS-REFERENCE TO RELATED APPLICATIONS

This application is a continuation of International Patent Application No. PCT/NZ2022/050098, filed Jul. 18, 2022, pending, and claims priority to Australian Patent Application No. 2021104227, which was filed Jul. 16, 2021, which are incorporated herein by reference in their entireties.

### TECHNICAL FIELD

The present invention relates to moving animals in a pastoral environment from their current location to a more desirable location to defecate or urinate (void). More particularly but not exclusively, it relates a wearable device to send a suggestion to a bovine animal to move away from less desirable locations such as waterways, to more desirable locations, such as areas of carbon-rich soil or areas where previous animals have not voided recently. The invention further relates to cueing an animal to move whilst voiding in order to distribute the void area, as well as cueing an animal to void whilst in a desirable area.

### BACKGROUND OF THE INVENTION

Nitrate leaching from agricultural soils has been identified as posing a potential threat to groundwater quality in New Zealand. Nitrate leaching from dairy farms may be due to high concentrations of nitrogen in animal urine, specifically dairy cow animals.

The urea in cow urine is hydrolysed to ammonium (NH4+), which is then nitrified, with denitrification of nitrate (NO3−) ensuing. Nitrous oxide (N2O), a potent greenhouse gas (GHG), is produced via nitrification and denitrification, which are enzyme-catalysed processes mediated by soil microbes.

Some approaches to regulating nitrate leaching are better pasture management, improved soil health, waterway and riparian management etc. These methods may require high capital input and high labour input, such as fencing off waterways and moving animals for strip grazing. There are further methods to reduce nitrogen on pasture or soil, including catchment of animal waste, which may be considered inhumane if done on animals, or contrary to farming practising if animals are required to stay in a barn configured to collect the waste. A further method is described in the MDPI journal paper ‘How Can Cattle Be Toilet Trained? Incorporating Reflexive Behaviours into a Behavioural Chain Neele Dirksen’ where animals are trained via pavlovian conditioning to move to a latrine. Where the animals were trained with rewards when they went to the latrine if they were going to urinate.

NZ738417A describes a distribution device to splash and redirect urine into a larger area as it leaves a cattle animal. U.S. Pat. No. 9,883,656B1 and CN112762922A disclose some sort of pet or animal sensor and are configured to prevent an animal from urinating.

### OBJECT OF THE INVENTION

It is an object of the present invention to provide an apparatus and method therefor for locational control of animal voiding that overcomes or at least partially ameliorates some of the abovementioned disadvantages or which at least provides the public with a useful choice.

### SUMMARY OF THE INVENTION

In a first aspect, the invention resides in an animal guidance system operable to guide the animal to a desired (untrained) target location for the animal to void at, the system comprising:
a. a wearable apparatus adapted to be worn by an animal, the apparatus comprising at least one stimulus device operable to administer at least one form of stimulus to the animal and guide the animal to the target location;
b. at least one positioning system configured to output animal location data;
c. at least one animal activity sensing device configured to output animal activity data;
d. at least one controller module configured to:
   i. receive the animal location data;
   ii. receive the animal activity data;
   iii. determine voiding information from the animal location data and/or animal activity data; and
   iv. operate the at least one stimulus device to administer the stimulus to guide the animal based on the determined voiding information to the target location.

In one embodiment, the target location is selected from a ranked list of voiding positions, and the controller is further configured to:
i. determine the animal position is at, or has been at, a first voiding position in the ranked list, and
ii operate the at least one stimulus device to administer the stimulus to guide the animal to the next voiding position in the ranked list.

In one embodiment, the determining of voiding information comprises a determination that the animal voiding is soon, is imminent, is commencing, or is occurring.

In one embodiment, the animal location data comprises an animal location or an animal part location.

In one embodiment, the controller module is further configured to store location information, and activity information, to thereby compile historical location information and historical activity information, and operate the at least one stimulus device to guide the animal to the target location based on the historical location information and historical activity information.

In one embodiment, the controller is configured to determine voiding information based on a pattern or routine within data representing one or more of:
i. location information from the animal location data,
ii. historical location information from the animal location data,
iii. activity information from the animal activity data, and/or
iv. historical activity information from the animal activity data; and operate the at least one stimulus device based on the voiding information.

In one embodiment, the target location is based on a selection of one or more of:
i. a distribution location;
ii. a preferable location preferable for voiding; and
iii. a distant location which is preferable not to be voided on.;/or
iv. a ranked list of target voiding locations.

In one embodiment, the controller is configured to store a list of preferable locations comprising position information pertaining to:
i. a location comprising nitrogen or other chemically deficient areas;
ii. a location comprising carbon-rich soil;
iii. a location comprising a preferred soil macro-porosity;
iv. an environmentally friendlier location than the animal's current location;
v. a location which is higher than the current location, or of a minimum height; and
vi. a location comprising lower quality pasture
vii. a location comprising an effluent catchment area or like location.

In one embodiment, the controller is configured to operate the at least one stimulus device based on the preferable locations.

In one embodiment, the controller is configured to store a list of distant locations comprising position information pertaining to:
i. a waterway,
ii. a wetland,
iii. a high slope area,
iv. an eroded area,
v. an area of exposed soil,
vi. a pugged area,
vii. a location of previous voiding from the animal or another animal,
viii. a historical voiding location,
ix. a high pasture growth area,
x. a nitrogen or other chemically rich area,
xi. a camping location of the herd,
xii. a gate,
xiii. a trough,
xiv. a tree,
xv. a fenceline,
xvi. a low lying area; and
xvii. a historical target location.

In one embodiment, the controller is configured to operate the at least one stimulus device based on the distant locations.

In one embodiment, the controller is configured to operate the stimulus device to:
i. move the animal to the target location, that differs from the animal's its current position; before, during or after the voiding event; or
ii. rotate, or move at least part of the animal, to the target location so as to distribute the voiding.

In one embodiment, the target location comprises at least a target location at a first voiding position, and a target location at a second voiding position, and the controller is further configured to:
i. determine the animal position is at the first voiding position, and
ii. operate the at least one stimulus device to administer the at least one form stimulus to guide the animal to the second voiding position based on the determined voiding information and the determination the animal position is at, or has been at, the first voiding position.

In a second aspect, the invention resides in an animal guidance system operable to guide the animal to an untrained target location for the animal to void at, the system comprising:
a. a wearable apparatus adapted to be worn by an animal, the apparatus comprising at least one stimulus device operable to administer at least one form of stimulus to the animal and guide to the animal to the target location;
b. at least one positioning system configured to output animal location data;
c. at least one animal activity sensing device configured to output animal activity data;
d. at least one controller module configured to:
   i. receive the animal location data;
   ii. receive the animal activity data;
   iii. determine voiding information from the animal location data and/or animal activity data; and
   iv. operate the at least one stimulus device to administer the stimulus to guide the animal based on the determined voiding information to the target location.

In a third aspect, the invention resides in an animal guidance system operable to guide the animal to an untrained target location for the animal to void at, the system comprising:
a. a wearable apparatus adapted to be worn by an animal, the apparatus comprising at least one stimulus device operable to administer at least one form of stimulus to the animal and guide to the animal to the target location;
b. at least one positioning system configured to output animal location data;
c. at least one animal activity sensing device configured to output animal activity data;
d. at least one controller module configured to:
   i. receive the animal location data; and
   ii. receive the animal activity data; and
wherein the controller is configured to determine if the animal is leaving or entering a paddock and directs the animal via operation of the stimulus device to the target location prior to leaving the paddock or upon entering the paddock, wherein the target location is within the paddock, and holding the animal at the staged location until the animal has voided.

In fourth first aspect, the invention resides in an animal guidance system operable to guide the animal to an untrained target location for the animal to void at, the system comprising:
a. a wearable apparatus adapted to be worn by an animal, the apparatus comprising at least one stimulus device operable to administer at least one form of stimulus to the animal and guide to the animal to the target location;
b. at least one positioning system configured to output animal location data;
c. at least one animal activity sensing device configured to output animal activity data;
d. at least one controller module configured to:
   i. receive the animal location data; and
   ii. receive the animal activity data; and
wherein the controller is configured to determine if the animal is going to form a campsite, and prior to forming the campsite directing the animal via operation of the stimulus device to the target location.

In a fifth aspect, the invention resides in a method of relocating a cattle animal to perform a voiding event in a target location, the method comprising the steps of a controller:
a. determining when a voiding event will occur, or is occurring, based on one or both of;
   i. a routine determined from one or more of
      a. current location information of the animal;
      b. current activity information of the animal;
      c. historical location information of the animal; and
      d. historical activity information of the animal; and
   ii. when the activity information indicates the animal voiding is soon, imminent, commencing, or occurring;
b. determining a location of the target location, and
c. administering a stimulus to the animal to guide or move the animal to said target location.

In a sixth aspect, the invention resides in a wearable apparatus adapted to be worn by an animal, the apparatus comprising a controller to a) determine when the animal will void, and b) control a stimulus device operable to administer at least one form of stimulus to the animal to guide the animal to a target location for said voiding, said target location being more desirable than the animal's current location for voiding.

In a seventh aspect, the invention resides in a wearable device configured to be worn by an animal and configured for administering a stimulus to the animal for suggesting movement to the animal to move the animal to a target location for voiding, wherein the wearable device comprises
a. at least one stimulus device configured to administer at least one form of stimulus to the animal that is able to be sensed by the animal,
b. at least one position sensing device configured to detect at least one position of at least part of the animal as at least one position value;
c. at least one controller that is operatively connected to the at least one position sensing device configured to send a control signal to the at least one stimulus device,
wherein the one position value relates to, or is used to determine, one or both of;
   i. location information relating to a location of the animal; and
   ii. activity information relating to an activity of the animal; and
the controller determining or receiving void information on when a voiding event will occur, or is occurring, based on one or both of;
   i. when an animal will likely void determined from one or more selected from; location information pertaining to the animal's location, historical location information, activity information, and historical activity information; and
   ii. when the activity information pertaining to the activity of the animal indicates the animal voiding is soon, imminent, commencing, or occurring; and
wherein the controller is configured to send the control signal to the at least one stimulus device should a voiding event be determined as occurring or will occur, the at least one stimulus device configured to administer the stimulus to the animal to suggest to the animal to move to said target location.

In one embodiment, when an animal will likely void is based on a routine determined from one or more selected from; location information, historical location information, activity information, and historical activity information.

In one embodiment, historical location information is location information relating to the location of the animal in the past.

In one embodiment, historical activity information is activity information relating to the activity of the animal in the past.

In one embodiment, the void event occurs at a void location.

In one embodiment, the animal before moving is located at its current location.
a. In one embodiment, the movement of the animal is one or more selected from
b. Transferring to the target location
c. Rotation of the animal to the target location

In one embodiment, transferring the animal comprises moving the animal to a target location, that differs from its current location; before, during or after the voiding event.

In one embodiment, rotation of the animal comprises moving at least part of the animal, or rotating the animal within substantially the same location to distribute the voiding.

In one embodiment, the target location is, or is determined by utilising, one or more selected from;
a. a distribution location; and
b. a preferable location that is preferable to be voided on.

In one embodiment, the target location is determined by utilising one or more selected from;
a. a distribution location;
b. a preferable location that is preferable to be voided on; and
c. a distant location which is preferable not to be voided on.

In one embodiment, a preferable location is one or more of selected from;
a. a location comprising nitrogen or other chemically deficient areas;
b. a location comprising carbon-rich soil;
c. a location comprising a preferred soil macroporosity
d. an environmentally friendlier location than the animal's current location; and
e. a location that is higher than the current location, or of a minimum height.

In one embodiment, the distant location is one or more selected from;
a. a waterway,
b. a wetland,
c. a high slope area,
d. an eroded area,
e. an area of exposed soil,
f. a pugged area,
g. a location of previous voiding from the animal or another animal,
h. a historical voiding location and/or historical target location
i. a high pasture growth area,
j. a nitrogen or other chemically rich area,
k. a camping location of the herd,
l. a gate,
m. a trough,
n. a tree,
o. a fenceline, and
p. a low lying area.

In one embodiment, the target location is a distance away from the known distant location.

In one embodiment, the distance away is between one and ten metres.

In one embodiment, the distant location does not change over time, and preferably does not change over a short period of time.

In one embodiment, the animals are confined or restricted to movement within a paddock.

In one embodiment, the preferable location, distant location, and distributed location are located within the paddock.

In one embodiment, the controller, a processor, or both, determine one or more of the target location; distributed location; and void information.

In one embodiment, the controller or processor determines the location of the animal is located at a distant location and will determine the target location as a location distant the distant location.

In one embodiment, the processor is located on the wearable device.

In one embodiment, the processor is located, and remote to, off the wearable device.

In one embodiment, the processor is located on a remote computer, the cloud, and/or a user device.

In one embodiment, the processor is in communication with the controller.

in one embodiment, the processor is or is part of a computer.

In one embodiment, the wearable device comprises a transceiver.

In one embodiment, the wearable device comprises a transceiver to allow communication between the controller and processor.

Staged

In one embodiment, the controller is configured to determine if the animal is leaving or entering the paddock and directs the animal to a staged location prior to leaving or upon entering or shortly after entering

In one embodiment, the staged location is within the paddock.

In one embodiment, the staged location is a preferable location.

In one embodiment, the animal is held by the controller at the staged location until the animal has voided.

In one embodiment, the animal is held by the controller at the target location until the animal has voided.

Distribution

In one embodiment, within the paddock, there is a plurality of distribution locations.

In one embodiment, the distribution locations are distributed within the paddock.

In one embodiment, the distribution locations do not overlap with each other.

In one embodiment, the distribution location is not co-located with a distant location.

In one embodiment, the distribution location is the target location.

In one embodiment, after a first voiding event, the animal will have a second voiding event.

In one embodiment, the first voiding event and second voiding event are preferably located at target locations that are not co-locatory.

In one embodiment, the first voiding event has a void location at a first distribution location, and the second voiding event has a void location at a second or subsequent distribution location

In one embodiment, the first distribution location is not co-located with the second or subsequent distribution location.

In one embodiment, the first distribution location is co-located or the same as a first target location, and the second or subsequent distribution location is co-located or the same as a second or subsequent target location.

In one embodiment, the target location differs between voiding events.

In one embodiment, the target location and/or preferred location is not a pre-trained location known or trained to the animal.

In one embodiment, the target location is a unique location for every voiding event.

In one embodiment, the target location differs between some voiding events.

Stimulus

In one embodiment, the stimulus device is or comprises at least two speakers, each of the speakers being configured to be positioned proximal to an ear for the animal to generate the at least one first stimulus in a form of an audible sound to the animal when the device is secured to the animal, wherein at least one of the speakers is to contact a left side of the neck of the animal and at least another one of the speakers is to contact a right side of the neck of the animal, the respective speakers are configured to play a sound to the left and right ears of the animal.

In one embodiment, the stimulus device is configured to administer a stimulus in the form of a sound to the left ear of the animal to suggest movement of the animal to the right, and administer a stimulus in the form of a sound to the right ear of the animal to suggest movement of the animal to the left.

In one embodiment, the controller is configured to continue to control the stimulus device so to in operation continue to guide the animal until the animal has reached the target location.

In one embodiment, the stimulus device is or comprises at least one vibrator configured to generate at least one stimulus in a form of a vibration to be felt by the animal when the device is secured the animal.

In one embodiment, the device further comprises a solar panel to provide electrical power to the at least one stimulus device.

In one embodiment, the physical response is a movement of the head of the animal in at least one of a left and right direction.

In one embodiment, the at least one stimulus device comprises at least one electrode and the stimulus is an electric shock that is configured to be sensed by the animal, the electric shock being generated by the at least one electrode.

In one embodiment, at least the at least one stimulus device is adapted to be carried by the animal.

Position Sensing

In one embodiment, the device comprises or is in electronic communication with at least one sensing device, the at least one sensing device being configured to determine at least one position of the animal.

In one embodiment, the at least one position is the angular position of at least part of the animal.

In one embodiment, the at least one position is the location of at least part of the animal.

In one embodiment, the device comprises an inertial measurement unit (IMU) to provide information of the condition of the device, the information comprising of at least one of:
(a) an indication that the movement of the device is in an up and down direction to indicate that the animal is eating food from a location lower than its normal standing and/or resting condition, and
(b) an indication that the movement of the device is in a left and right direction to indicate that the animal is turning its head to either a left or right direction.

In one embodiment, the device comprises a navigation device to provide location information of the device to at least one of the local and remote locations.

In one embodiment, the at least one position is an angular position of at least part of the animal.

In one embodiment, the angular position is measured in three orthogonal directions, the three orthogonal directions being roll, pitch and yaw.

In one embodiment, the angular position is of at least one of the head and the neck of the animal and is measured in three orthogonal directions, the three orthogonal directions being roll, pitch and yaw.

In one embodiment, the at least one sensing device comprises an inertial measurement unit.

In one embodiment, the location device is a GPS unit.

In one embodiment, the device is in a form of a collar configured to be worn around the neck or tail of the animal.

In one embodiment, the device comprises both a neck collar and tail collar.

In one embodiment, the device comprises one or both of a
a. GPS module to aid in determining location information of the animal
b. one or more of a gyroscope, accelerometer, IMU, and magnetometer; configured to aid in determining activity information relating to the activity of the animal,

In one embodiment, the controller is attached to or is inside the wearable device.

In one embodiment, the at least one controller is in electronic communication with at least one sensing device that is configured to detect at least one position of at least part of the animal as at least one position value and the controller being programmed to read and compare the at least one position value with at least one predetermined value relating to the at least one position to determine if the control action is required, the control action being transmitting of at least one control signal to the stimulus device to apply the at least one form of stimulus to the animal.

In one embodiment, the device is in electronic communication with at least one transmitting device adapted to transmit a signal representing the at least one position value from the sensing device to the controller, and to transmit the control signal to the stimulus device if the controller determines or receives a control command that the control action is required.

In one embodiment, the at least one sensing device comprises a gyroscope.

In one embodiment, the at least one transmitting device is part of the apparatus.

In one embodiment, the at least one transmitting device is a transceiver.

In one embodiment, the at least one controller comprises and is in electronic communication with a memory for storing at least the predetermined value.

In one embodiment, the memory is a Random Access Memory (RAM).

In one embodiment, the memory is an Electrically Erasable Programmable Read-Only Memory (EEPROM).

In one embodiment, the at least one sensing device is a position sensing device which comprises or is in electronic communication with at least one navigation means that is in electronic communication with the at least one controller, the at least one navigation means being configured to determine a location of the animal as the position value and transmit a signal representing the at least one position value to the at least one controller.

In one embodiment, the at least one navigation means is or uses a Global Positioning System (GPS) or a Local Positioning System (LPS).

In one embodiment, the at least one navigation means is or uses a Global Positioning System (GPS) and the at least one position value is made up of at least two GPS coordinates.

In one embodiment, the at least one controller is in electronic communication with a remote processor and is configured to perform the control action on the basis of a command received from the remote processor.

In a eighth aspect, the invention resides in a method of relocating a cattle animal to perform a voiding event in a target location, the method comprising the steps of:
a. detecting one or both of;
   i. location information relating to a location of the animal; and
   ii. activity information relating to an activity of the animal;
b. determining when the voiding event will occur, or is occurring, based on one or both of;
   i. a routine determined from one or more of
      a. current location information;
      b. current activity information;
      c. historical location information; and
      d. historical activity information; and
   ii. when the activity information indicates directly or indirectly that the animal voiding is soon, imminent, commencing, or occurring; and
c. administering a stimulus to the animal to guide or move the animal towards said target location.

In one embodiment, the detecting the step comprises detecting at least one position of at least part of the animal as at least one position value; wherein the one position value relates to, or is used to determine, location information relating to a location of the animal; and activity information relating to an activity of the animal.

In one embodiment, the voiding event occurs at a void location.

In one embodiment, the movement of the animal is one or more selected from
a. Transferring to the target location; and
b. Rotation of the animal to the target location.

In one embodiment, transferring the animal comprises moving the animal to a target location, that differs from the animal's current location; before, during or after the voiding event.

In one embodiment, rotation of the animal comprises moving at least part of the animal, or rotating the animal within substantially the same location to distribute the voiding.

In one embodiment, the method includes the step of determining the location of the target location.

In one embodiment, the method includes the step of receiving the location of the target location.

In one embodiment, the target location is, or is determined by utilising, one or more selected from;
a. a distribution location; and
b. a preferable location that is preferable to be voided on.

In one embodiment, the target location is determined by utilising one or more selected from;
a. a distribution location;
b. a preferable location that is preferable to be voided on; and
c. a distant location which is preferable not to be voided on.

In one embodiment, a preferable location is one or more of selected from;
a. a location comprising nitrogen or other chemically deficient areas;
b. a location comprising carbon-rich soil;
c. a location comprising a preferred soil macroporosity;
d. an environmentally friendlier location than the animal's current location; and
e. a location that is higher than the current location, or of a minimum height.

In one embodiment, the distant location is one or more selected from;
a. a waterway,
b. a wetland,
c. a high slope area,
d. an eroded area,
e. an area of exposed soil,
f. a pugged area,
g. a location of previous voiding from the animal or another animal,
h. a historical voiding location,
i. a high pasture growth area,
j. a nitrogen or other chemically rich area,
k. a camping location of the herd,
l. a gate,
m. a trough,
n. a tree,
o. a fenceline, and
p. a low lying area.

In one embodiment, the method further comprises the step of determining the target location via
a. assigning a weighting to the preferable location depending on how preferable the location is,
b. assigning a weighting to the distant location depending on how unpreferable the location is,
c. generating a ranked list based on the preferable location weighting and distant location weighting,
d. selecting the target location from the ranked list.

In one embodiment, the method further comprises the step of determining the target location via
a. giving a weighting to the preferable location depending on how preferable the location is,
b. giving a weighting to the distant location depending on how unpreferable the location is,
c. summing the differences between the preferable weighting and distant weighting to determine the desirability ranking of each location, and ranking them as ranked locations,
e. selecting the target location from the ranked locations.

In one embodiment, the method further comprises the step of selecting the target location from one of the more higher ranked locations.

In one embodiment, the method further comprises the step of selecting the target location from a ranked location ranked above a set desirability ranking.

In one embodiment, the method comprises selecting multiple ranked locations as multiple target locations for subsequent void events.

In one embodiment, the method comprises selecting one or more ranked locations as either or both distributed locations and target locations.

In one embodiment, the step of determining the ranked location, distributed locations, and/or target location is performed on a computer.

In one embodiment, the method includes the step of attaching a wearable device on the animal, the wearable device comprising.
at least one stimulus device to administer at least one form of stimulus to the animal that is able to be sensed by the animal;
at least one position sensing device configured to detect at least one position of at least part of the animal as at least one position value; and
at least one controller that is operatively connected to the at least one position sensing device configured to send the control signal to the at least one stimulus device.

In one embodiment, the at least one controller continues to control the at least one stimulus device to continually provide guidance to the animal to move the animal from its current location to the target location.

In one embodiment, the method includes the step of the controller determining or receiving void information on when a voiding event will occur, or is occurring, based on one or both of;
when an animal will likely void based on a routine determined from one or more selected from; location information, historical location information, activity information, and historical activity information; and
when the activity information indicates the animal voiding is soon, imminent, commencing, or occurring.

In one embodiment, the one position value relates to, or is used to determine, one or both of;
a. location information relating to a location of the animal; and
b. activity information relating to an activity of the animal.

In one embodiment, the determination of the target location and/or distributed location is determined by a controller, computer and/or processor located on or off the wearable device.

In one embodiment, the controller is configured to send the control signal to the at least one stimulus device should the voiding information indicate that a voiding event is or will occur, the at least one stimulus device delivering a stimulus or stimuli to the animal to in operation suggest to the animal to move to said target location.

In a ninth aspect, the invention resides in a method of relocating a cattle animal to perform a voiding event in a target location, the method comprising the steps of:
a. determining when the voiding event will occur, or is occurring, based on one or both of;
i. a routine determined from one or more of
a. current location information of the animal;
b. current activity information of the animal;
c. historical location information of the animal; and
d. historical activity information of the animal; and
ii. when the activity information indicates the animal voiding is soon, imminent, commencing, or occurring; and
a. determining a location of the target location,
b. administering a stimulus to the animal to guide or move the animal to said target location.

In one embodiment, the target location is a more environmentally friendly location than the animals current location prior to the voiding event.

In one embodiment, the target location is, or is determined by utilising, one or more selected from;
a. a distribution location; and
b. a preferable location that is preferable to be voided on.

In one embodiment, the target location is determined by utilising one or more selected from;
a. a distribution location;
b. a preferable location that is preferable to be voided on; and
c. a distant location which is preferable not to be voided on.

In one embodiment, a preferable location is one or more of selected from;
a. a location comprising nitrogen or other chemically deficient areas;
b. a location comprising carbon-rich soil;
c. a location comprising a preferred soil macroporosity;
d. an environmentally friendlier location than the animal's current location; and
e. a location that is higher than the current location, or of a minimum height.

In one embodiment, the distant location is one or more selected from;
a. a waterway,
b. a wetland,
c. a high slope area,
d. an eroded area,
e. an area of exposed soil,
f. a pugged area,
g. a location of previous voiding from the animal or another animal,
h. a historical voiding location and/or historical target location,
i. a high pasture growth area,
j. a nitrogen or other chemically rich area,
k. a camping location of the herd,
l. a gate,
m. a trough,
n. a tree,
o. a fenceline, and
p. a low lying area.

In one embodiment, within the paddock there is a plurality of distribution locations.

In one embodiment, the distribution locations are distributed within the paddock.

In one embodiment, the distribution locations do not overlap with each other.

In one embodiment, the distribution location is not co-located with a distant location.

In one embodiment, the distribution location is a target location.

In one embodiment, after the (first) voiding event, the animal will eventually have a second or subsequent voiding event.

In one embodiment, the first voiding event and second or subsequent voiding event are located at target locations that are not co-locatory.

In one embodiment, the first voiding event has a void location at a first distribution location, and the second or subsequent event has a void location at a second or subsequent distribution location, wherein the first distribution location is not co-located with the second or subsequent distribution location.

In one embodiment, the method further comprises the step of determining the target location via
a. assigning a weighting to the preferable location depending on how preferable the location is,
b. assigning a weighting to the distant location depending on how unpreferable the location is,
c. generating a ranked list based on the preferable location weighting and distant location weighting,
d. selecting the target location from the ranked list.

In one embodiment, the method further comprises the step of selecting the target location from one of the more higher-ranked locations.

In one embodiment, the method further comprises the step of selecting the target location from a ranked location ranked above a set desirability ranking.

In one embodiment, the method comprises selecting multiple ranked locations as multiple target locations for subsequent void events.

In one embodiment, the method comprises selecting one or more ranked locations as either or both distributed locations and target locations.

In one embodiment, the target location is any location that is not co-located with the distant location.

In one embodiment, the method comprises the step of detecting at least one position of at least part of the animal as at least one position value; wherein the one position value relates to, or is used to determine, one or both of;
a. location information relating to a location of the animal; and
b. activity information relating to an activity of the animal.

In a tenth aspect, the invention resides in a wearable apparatus adapted to be worn by an animal, the apparatus comprising a controller module to a) determine when the animal will void, and b) control a stimulus device operable to administer at least one form of stimulus to the animal and guide to the animal to a target location for said voiding which is more desirable than the animal's current location for voiding.

In one embodiment, the controller determines when the animal will void based on the one or both of animal position data and animal activity data.

In one embodiment, the apparatus comprises at least one positioning system configured to output animal position data.

In one embodiment, the apparatus comprises at least one animal activity sensing device configured to output animal activity data.

In one embodiment, the controller is configured to determine if the animal is leaving or entering a paddock and directs the animal via operation of the stimulus device to the target location prior to leaving the paddock or upon entering the paddock, wherein the target location is within the paddock, and holding the animal at the staged location until the animal has voided.

In one embodiment, the controller is configured to determine if the animal is going to form a campsite, and prior to forming the campsite directing the animal via operation of the stimulus device to the target location.

In an eleventh aspect, the invention resides in a controller operable to guide an animal to a desired (preferably untrained) target location for the animal to void at, the controller configured to:
I. receive animal position data from at least one positioning system;
II. receive animal activity data from at least one animal activity sensing device;
III. determine voiding information from the animal position data and/or the animal activity data; and
IV. output a control signal operable to administer a stimulus from a stimulus device worn by the animal to thereby to guide the animal based on the determined voiding information to the target location.

In one embodiment, the previous embodiments may relate to the above aspect.

In a twelfth aspect, the invention resides in a wearable device configured to be worn by an animal and operable to stimulate said animal, the wearable device comprising;
an animal activity sensing device configured to detect and record animal activity data relating to the initiation of or occurrence of voiding by said animal;
at least one stimulus device operable to administer at least one form of stimulus to the animal; and
a controller configured to
   determine the animal activity from activity data, and
   operate the at least one stimulus device to administer at least one form of stimulus to the animal in response to a determination of an initiation of or occurrence of voiding by said animal based animal activity.

In one embodiment, the wearable device comprises a position sensing device configured to determine a location of said animal.

In one embodiment, the wearable device comprises a collar device configured to be worn around the neck of said animal.

In one embodiment, the wearable device comprises a tail device configured to be worn proximally or on said animal's tail.

In one embodiment, the tail device is distinct and separate from the collar device, and the two devices are configured to communicate to each other at least in one direction from the tail device to the collar device.

In one embodiment, both the tail device and collar device are configured to communicate with each other via short and/or long range communications protocols.

In one embodiment, the tail device and collar device comprise one or more of bluetooth, LoRa, WiFi, NFC or other like protocol transmitters and receivers.

In one embodiment, the tail device is configured to detect initiation of or occurrence of voiding

In one embodiment, the tail device comprises the activity sensing device.

In one embodiment, the activity sensing detects and records movement data of the tail.

In one embodiment, the activity sensing device comprises or is an inertial measurement unit or accelerometer.

In one embodiment, the collar device comprises the at least one stimulus device.

In one embodiment, one or both of the collar device and tail device comprise at least one controller.

In one embodiment, the tail device comprises a controller configured to
a. receive the animal activity data from the sensing device; and
b. send the animal activity data to the collar device.

In one embodiment, the animal activity data is averaged or compressed.

In one embodiment, the tail controller is configured to:
a. receive the animal activity data from the sensing device;
b. determine if the animal is voiding based on the animal activity data; and
c. operate the data transmission device to send said determination of voiding to a collar data receiver device if the animal is determined as voiding.
a.

In one embodiment, the tail controller is configured to:
a. receive the animal activity data from the sensing device;
b. determine if the animal is voiding based on the animal activity data, by utilising pattern recognition to compare the activity data with activity data of known voiding events; and
c. operate the data transmission device to send said determination of voiding to a collar data receiver device if the animal is determined as voiding.

In one embodiment, the at least one form of stimulus (herein a ‘moving stimulus’) is applied to one side of the animal via the at least one stimulus device in order to encourage the animal to move, turn, or re-orient.

In one embodiment, the stimulus is applied to either or both sides of the animal.

In one embodiment, the moving stimulus is applied to one side of the animal.

In one embodiment, the moving stimulus is applied to, or substantially more to, one ear of the animal during initiation of or occurrence of voiding by said animal to encourage the animal to move, turn, or re-orient.

In one embodiment, the moving stimulus is applied to the animal during initiation of or occurrence of voiding by said animal to encourage the animal to move, turn, or re-orient in order to increase the void area.

In one embodiment, the moving stimulus is a stimulus audible to the animal.

In one embodiment, the position sensing device is a GPS.

In one embodiment, the collar device controller is configured to determine if said location of said animal matches a target location, where the target location is a location which has been designated appropriate for the animal to void.

In one embodiment, the collar controller is configured to control the stimulus from the at least one stimulus device.

In one embodiment, the collar controller has access to a list of target locations.

In one embodiment, the collar controller is configured to apply a stimulus (herein a ‘cueing stimulus’) from the at least one stimulus device to the animal when the location of said animal matches a target location, and the animal has been detected as not voiding.

In one embodiment, the wearable device is configured to apply a stimulus (herein a ‘training stimulus’) from the at least one stimulus device to the animal when the location of said animal matches a target location, and the animal has been detected as voiding.

In one embodiment, the target location is one or more selected from:
a. a location comprising nitrogen or other chemically deficient areas;
b. a location comprising carbon-rich soil;
c. a location comprising a preferred soil macro-porosity;
d. an environmentally friendlier location than the animal's current location;
e. a location which is higher than the current location, or of a minimum height;
f. a location comprising lower quality pasture;
g. a location comprising an effluent catchment area or like location;
h. a milking shed, yard, or part thereof;
i. a stand-off pad; and
j. a urine collection area.

In one embodiment, the stimulus is a sound, vibration, and/or shock.

In one embodiment, the cueing stimulus and training stimulus are the same stimulus.

In one embodiment, the cueing stimulus occurs once in a time period, or once per target location.

In one embodiment, voiding is one or both of defecation or urination, or general excreta.

In one embodiment, the cueing stimulus is not applied by the controller if the training stimulus has already been applied whilst the animal is still in said target location.

In a thirteenth aspect, the invention resides in a method for optimising void locations of an animal, wherein the method comprises the steps of
a. attaching a wearable device to said animal comprising,
   i. an animal activity sensing device configured to detect and record animal activity data relating to the initiation of or occurrence of voiding by said animal;
   ii. at least one stimulus device operable to administer at least one form of stimulus when the activity sensing device detects animal activity data relating to the initiation of or occurrence of voiding by said animal to said animal;
   iii. a controller to receive animal activity data and control the at least one stimulus device; and
b. detecting, with the activity sensing device, activity data relating to the initiation of or occurrence of voiding by said animal; and
c. applying at least one stimulus from the at least stimulus device to the animal when the sensing device detects initiation of or occurrence of voiding, to either
   i. encourage the animal to turn or re-orient whilst voiding, or
   ii. condition or train the animal to void.

In one embodiment, void area is the area of ground the voiding contacts.

In one embodiment, the wearable device comprises a position sensing device configured to determine the location of said animal.

In one embodiment, the method comprises the steps of the controller
a. determining location of said animal via position sensing device;
b. determining if location of said animal matches a target location, where the target location is a location which has been designated appropriate for the animal to void;
c. determining if the activity sensing device detects initiation of or occurrence of voiding; and
d. applying
   i. a moving stimulus from the at least one stimulus device if the animal location is not in a target location to encourage the animal to turn or re-orient whilst voiding, or
   ii. a training stimulus from the at least one stimulus device if the animal location is in a target location to condition the animal to void.

In one embodiment, the method comprises the steps of the controller,
a. determining location of said animal via position sensing device;
b. determining if location of said animal matches a target location, where the target location is a location which has been designated appropriate for the animal to void;
c. determining if the activity sensing device does not detect initiation of or occurrence of voiding,
d. applying a cueing stimulus if the animal location is in a target location.

In one embodiment, the wearable device is as claimed in any one of claims 1 to 19.

In one embodiment, the wearable device applies the cueing stimulus after a trigger event is received.

In one embodiment, the trigger event is lapsation of a time period since entering the target location, or the determination of the animal leaving the target location.

In one embodiment, the at least one stimulus device is a speaker, and the at least one stimulus is a sound audible to said animal.

In one embodiment, the moving stimulus is an audible stimulus audible to at least one ear of the animal configured to reorient the animal.

In one embodiment, the moving stimulus is a vibration and/or electric pulse.

In one embodiment, the cueing stimulus and training stimulus are the same or substantially the same stimulus.

In one embodiment, the cueing and/or training stimulus is a vibration applied to the neck of the animal, or a sound applied to both ears of an animal.

In one embodiment, the animal is a cow which urinates from near its tail, and re-orientating the cow moves the head of the cow around, and therefore the tail end of the cow around also, to distribute the urine patch.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, a reference to such external documents is not to be construed as an admission that such documents, or such sources of information, in any jurisdiction, are prior art, or form part of the common general knowledge in the art.

It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’ or ‘configured’ for the purpose that is stated.

For the purposes of this specification, the term “plastic” shall be construed to mean a general term for a wide range of synthetic or semisynthetic polymerization products, and generally consisting of a hydrocarbon-based polymer.

For the purpose of this specification, where method steps are described in sequence, the sequence does not necessarily mean that the steps are to be chronologically ordered in that sequence, unless there is no other logical manner of interpreting the sequence.

The entire disclosures of all applications, patents and publications, cited above and below, if any, are hereby incorporated by reference.

### BRIEF DESCRIPTION OF THE DRAWINGS

Preferred embodiments of the invention will be described by way of example only and with reference to the drawings, in which:

FIG. 1: shows one example of a general communication system infrastructure diagram incorporating the features of the invention in an example where a position and/or activity of an animal in a field is being recorded according to the present invention.

FIG. 2: shows a wearable device on an animal to be used in the system of the present invention.

FIG. 3: is a table of OBDA data and pitch correlations with movement of a wearable device.

FIG. 4: is a table of activity data and probability correlations with movement of a wearable device.

FIG. 5: is a schematic diagram of an animal in a paddock with graphical representations of various potential locations.

FIG. 6: is a block diagram of inputs able to be used to determine the target location.

FIG. 7: shows a front view of a wearable device.

FIG. 8: is a block diagram showing one possible embodiment of the wearable device configuration.

FIG. 9: is a block diagram showing one further possible embodiment of the wearable device configuration.

FIG. 10: is a block diagram showing one possible embodiment of the system and wearable device configuration.

FIG. 11: is a block diagram showing one possible embodiment of applying a stimulus to the animal.

FIG. 12: is a block diagram showing one possible embodiment of the system determining animal location.

FIG. 13: is a block diagram showing one possible embodiment of the system determining animal activity.

FIG. 14: is a block diagram showing one possible embodiment of the system with both a tail device and collar device.

### DETAILED DESCRIPTION

With reference to the above drawings, in which similar features are generally indicated by similar numerals, a system according to a first preferred embodiment of the invention is generally indicated by the numeral 18.

The present invention comprises a wearable device 20 configured to be worn by an animal 1, preferably a bovine animal 1. The invention may be a system 18, comprising a wearable device 20 any number of processors configured as a control system. Such an animal 1 may be one of a dairy cow, beef animal, goat, bison, sheep, bull, lama or any other animal that is able to be grazed outside and is desirable to locate or distribute their voiding (i.e urinating or defecating) events. In particular, this invention relates to cattle that primarily feed on pasture or crops within paddocks 2. The animal 1 may form part of a herd of animals where each animal 1 in the herd wears a device 20.

The device 20 comprises functionality to suggest directing an animal 1 to a target (desired) location 8 in a paddock 2 within which the animal 1 resides. There are three important factors to this invention. The first is determining when the animal 1 will void, and the second is determining where the animal 1 should void, and the third is to suggest to the animal 1 to move to a location to void. The wearable device 20 utilises technology by the company HALTER® and is further described in patent publications WO2019180624 and WO2019180623. The HALTER® technology is capable of restraining an animal 1 in a zone 2 defined by a virtual boundary 3, as well as being able to shift the animal 1 from the zone to another location such as a milking shed or another zone. The wearable device 20 achieves this via audible signals to the left and right ears of the animal 1, and/or in combination with vibration or electrical stimulus. The wearable device 20 utilises electronics and/or software to control stimuli using control actions, as well as to communicate externally—such as to receive target locations 8 (aka voiding targets 8 or preferred locations) to void at, maps, instructions, control signals etc. The stimulus device 350 may be one or more of the following; piezo or speakers 350b, vibration drivers 350a, or electrical stimulus 350c. Where the stimulus device 350 may have left and right focused stimulus devices 350, e.g a left speaker 350a and right speaker 350a′ as shown in FIG. 7.

Determining when an animal 1 will void or is voiding is more difficult, and is based on one or more of the animal movement activity, animal location, routine, and time.

A lot of research has been undertaken to better understand how often (frequency), where, when, and how much cows void. In this specification, urination is described often, however is functionally interchangeable with defecation and voiding. Research on urination is more common and as such will be concentrated on in this specification. This is due to the higher nitrogen content in urination void events compared to defecation void events. The location of the void event is herein called the void location. The length of time of a void event is the void period and the area of ground or land impacted by the void event is the void area.

The following is a collection of research describing the state of the art and research relating to void events for dairy cows. This research can be used to create the patterns and algorithms for the present invention, however other research may also be used. The research gives a good idea of the present problems in the art, particular high nitrogen leaching on pasture from dairy cow urination. The following research is outlaid in K. BETTERIDGE, D. A. COSTALL, F. Y. LI, D. LUO and S. GANESH, 2013, Why we need to know what and where cows are urinating—a urine sensor to improve nitrogen model, AgResearch Grasslands, Private Bag 11008, Palmerston North, Proceedings of the New Zealand Grassland Association 75: 119-124.

Control System Overview

The herein described broad functionality is provided by a control system which may herein be referred to as a controller. The controller is implemented by one or more computing devices which form the architecture of a system configured to perform desired functions. Reference to “controller” may refer to one or more electronic devices that are configured to directly or indirectly communicate with, or over, one or more networks. The computing device may be a mobile device. As an example, a mobile device may include a smart wearable device such as a wearable animal collar (or “collar”), a cellular phone, smartphone, a portable computer, such as watches, glasses, lenses, clothing, and/or the like, and/or other like devices. In other non-limiting embodiments, the computing device may be a desktop computer or other non-mobile computer. Furthermore, the term “computer” may refer to any computing device that includes the necessary components to receive, process, and output data, and normally includes a display, a processor, a memory, an input device, and a network interface.

Any or a selection of computing devices is configured to communicate with any other computing device as desired, where the terms “communication” and “communicate” may refer to the reception, receipt, transmission, transfer, provision, and/or the like of information, such as data, signals, messages, instructions, commands, and/or the like. For one controller, such as a device, a system, a component of a device or system, combinations thereof, and/or the like to be in communication with another controller means that the one controller is able to directly or indirectly receive information from and/or transmit information to the other controller. This may refer to a direct or indirect connection that is wired and/or wireless in nature. Additionally, two controllers may be in communication with each other even though the information transmitted may be modified, processed, relayed, and/or routed between the first and second controller. For example, a first controller may be in communication with a second controller even though the first unit passively receives information and does not actively transmit information to the second unit. As another example, a first controller may be in communication with a second controller and at least one intermediary controller, where a third controller is located between the first controller and the second controller, processes information received from the first controller and communicates the processed information to the second controller. In some non-limiting embodiments, data or information may refer to a network packet such as a data packet, and/or the like that includes data. It will be appreciated that numerous other arrangements are possible.

Further, in some embodiments, there is a central or master controller which may be referred to as a server, or generally as the controller. The term server or controller may refer to or include one or more processors or computing devices, storage devices, or similar computer arrangements that are operated by or facilitate communication and processing for multiple parties in a network environment, although it will be appreciated that communication may be facilitated over one or more public or private network environments and that various other arrangements are possible. Further, multiple computers such as servers or other computerised devices, directly or indirectly communicating in the network environment may constitute the controller such as a computing device configured for central service control.

Reference to “a server” or “a processor,” as used herein, may refer to a previously-recited server and/or processor that is recited as performing a previous step or function, a different server and/or processor, and/or a combination of servers and/or processors, and refer to general implementations of processors which form the functional elements of the controller. For example, a first server and/or a first processor that is recited as performing a first step or function may refer to the same or different server and/or a processor recited as performing a second step or function. Further, reference to a server or processor may refer to a group of servers or group of processors, each configured to perform a task. Such tasks may include processes or algorithms which are undertaken by one or more servers of processors. Tasks undertaken by any one or more processors, such as by an on-collar and/or off-collar processor, are therefore to be understood as tasks undertaken by the controller.

Embodiments of this disclosure include reference to cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Some embodiments are private clouds where the cloud infrastructure is operated solely for an organisation. Other embodiments are community clouds, where cloud infrastructure is shared by several organisations and supports a specific community that has shared concerns such as security requirements, policy, or compliance considerations. The community cloud may be managed by the organisations or a third party and may exist on-premises or off-premises. In some embodiments, a public cloud infrastructure is made available to the general public or a large industry group and is owned by an organisation selling cloud services. A cloud computing environment is service-oriented with a focus on statelessness, low coupling, modularity, and semantic interoperability. At the heart of cloud computing is an infrastructure comprising a network of interconnected nodes. The cloud computing models may be managed by the organisation or a third party and may exist on-premises or off-premises. One applicable implementation model for the present disclosure is by Software as a Service (SaaS). SaaS is the capability provided to the consumer to use the provider's applications running on a cloud infrastructure. The applications are accessible from various client devices through a client interface such as a web browser. The consumer does not typically manage or control the underlying cloud infrastructure including network, servers, operating systems, storage, or even individual application capabilities.

Non-limiting embodiments or aspects of the present invention are directed to a method and system for controlling functions of a wearable animal collar which are operable to direct an animal to a target location, known as a voiding target, or target location 8. Control of the animal location is generally based on data informing animal voiding activity, herein referred to as “voiding information”, and in particular, control of the animal is to control the location of an animal based on information that voiding is occurring, has occurred, or is predicted to occur. Accordingly, some embodiments relate to an animal guidance system operable to guide the animal to a target location.

The animal guidance system has a wearable apparatus (collar) adapted to be worn by an animal as will be discussed in further detail below. However, the wearable apparatus has at least one stimulus device operable to administer at least one form of stimulus to the animal and guide the animal to the desired voiding target. Forms of stimulus will also be described in further detail below.

The animal guidance system further has at least one positioning system configured to output animal position data (location and/or activity) and voiding target position data. The guidance system may be provided by a GPS device located on the wearable apparatus, or local positioning system. Many forms of the positioning system are possible, and some of which are discussed in further detail below.

The animal guidance system further has at least one animal activity sensing device configured to output animal activity data. Animal activity data typically includes data relating to the movement of an animal as defined by one or more sensors configured to generate a signal based on a change on any one or more degrees of freedom as may be desired. Further detail on animal activity data and interpretation of said data to indicate animal activity is discussed below.

The animal guidance system further has at least one controller module configured to undertake particular functional requirements of the system. The specification below will discuss many functions in terms of desired outcomes, data and considerations to support those outcomes. It should be understood that for each outcome, the controller is configured to receive information, undertake any one or more functional steps based on the received information, and generate an output operable to achieve the stated outcome.

For example, in some embodiments, the controller is configured to receive the animal position data, receive the animal activity data, determine animal voiding information from the animal position data and/or animal activity data; and generate an output operable to control at least one stimulus device to administer the stimulus to guide the animal based on the determined voiding information and the target location.

In some embodiments, the controller is made up of several discrete processing devices, such as microprocessors or other equivalent form of computing device. Further, those processing devices are distributed over a variety of locations, and may be interconnected as a network. The processing devices of the network are connected wirelessly. A wearable animal apparatus may for example have a processor configured to receive and act on data from the animal positioning system and animal activity device. That data may be communicated via the network to one or more other processing devices. In some embodiments, one of the processing devices acts as a master device which connects to any number of other devices, collates data from any one of the number of other devices, makes decisions based on that collated data, then communicates instructions to any one or more of the other processing devices. For example, in some embodiments the controller has at least one master processing device connected to a number of other processing devices which are located on an animal wearable collar. In such embodiments, the master processing device acts as a first controller module part and the one or more collar processing devices acts as a second controller module part, the controller module parts acting together as the controller.

In some embodiments, functions of the controller are enabled according to a SaaS subscription status.

Slopes and Campsites

Betteridge et al. (1986) describe a wide range in urinary nitrogen concentration and urine volume amongst individual urination events by grazing steers. Campsites, which is where animals tend to congregate for periods of time, occupy 5-15% of a hill country paddock. According to the longer time spent in campsites by a large number of the cattle in a herd, campsites account for about half of all excreted urine. Campsite locations can be predicted for the targeting of nitrogen-loss mitigation strategies using a simple topographic map of the farm [Betteridge et al. (1986)]. In hill country paddocks, beef cows were shown to excrete about 50% of all urination events within 5-15% of the paddock area [Betteridge et al. 2010a,b], with these sites being typically found in low elevation, low-slope areas of the hill paddock.

A model predicted where stock camps would be found in a paddock, based on the independent variables slope, elevation, aspect, Northings and Eastings, in 25 m² grid cells 6 overlying the paddock map [Betteridge et al. 2012].

Concentration

Urine concentration can change over time, most concentrated at night until sunrise when animals rise and start to graze [Betteridge et al. 1986].

Animal Speed

Depending on cow velocity, standing, lying etc; determination of a likely upcoming or occurring urination event is possible.

Frequency

‘Urination behaviour by dairy cows grazing kale or fodder beet was highly variable, in both frequency and volume. The results are similar to previously published data, for example, Aland et al. (2002) found grazed dairy cows urinated on average 9.0 times per day (range 5-18); while Castle et al. (1950) reported a daily urine frequency of 9.8 times. During a grazing study in New Zealand, Draganova et al. (2010) found urination frequency was 0.5 events/hour/cow. These results suggest that while variation in urination frequency exists, the average dairy cow urinates between 7 and 13 times each day’ [Use of a urine meter to detect variation in urination behaviour of dairy cows on winter crops B L Ravera*, R H Bryant, K C Cameron, H J Di, G R Edwards and N Smith. Faculty of Agriculture and Life Sciences, Lincoln University, Proceedings of the New Zealand Society of Animal Production 2015. Vol 75: 84-88]

Functionality Options

The prior art has not tried to predict when a cow will void, and shift that cow prior to or during the voiding to an untrained location. This is a step-change way of thinking. At a high level, the invention comprises a device 20 that provides directional control stimulus and/or movement stimulus of the animal 1, and a controller operable to suggest a ‘target (desired) location 8’ for the animal 1 to locate to prior to voiding by operation of the directional control stimulus. The target location 8 may be one of many locations described later in the specification. For example, the target location 8 may be colocatory (in the same location) with a preferred location 4—which is a location that it would be preferable for the animal 1 to void on. Alternatively, the target location 8 may be a ‘distant location 5’ that avoids or is not colocatory with a preferred location 4. The distant location being a location that it is not preferable for an animal to void on.

The preferred location 4 and/or the distant location 5 may be related to a geographic feature in the paddock 2. Alternatively, or in addition, the target location 8 may be affected by a historical event such as a previous voiding event (when an animal, or the same animal 1, has voided previously at that location) at a void location (location of a voiding event). The distant location 5 may also be tied to the target location 8. The void location will have a corresponding void area 9, which is an area of ground that will likely be affected by the void event.

Distribution—Campsites/Herds

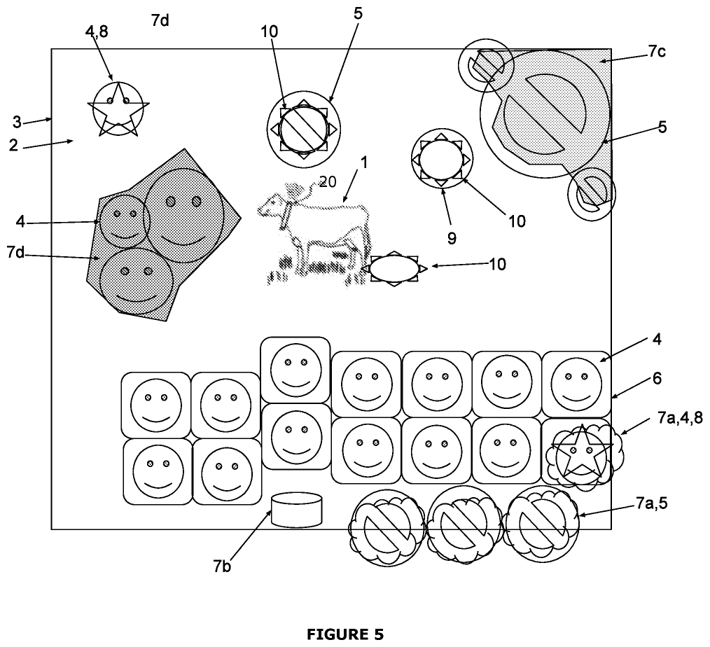

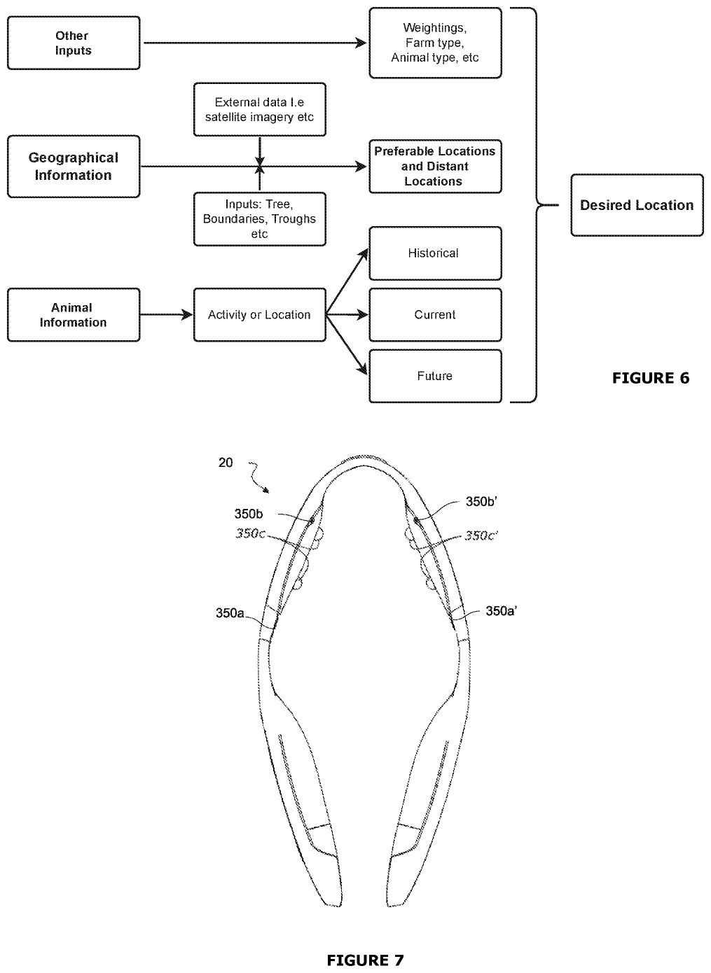

Due to the high nitrogen content in urine, it is preferable that multiple void locations are not in the same location, this can avoid very high nitrogen input to a small area. One solution would be to distribute the location of void events (void event location 10 as shown in FIG. 5) and thus void locations over a paddock 2 so that there is less likelihood of nitrogen accumulation in one area. Distribution can be achieved via moving a herd around a paddock 2 overtime, or during likely times of urination. This achieves a similar function to strip grazing, where void events are distributed evenly over a paddock 2.

Another option is to move the campsites of animals 1 around a paddock 2, so subsequent campsites do not overlap each other. Campsites, as discussed previously, are sources of high voiding events. So for example, a herd's campsite at night one could be shifted to be in a different location on night two. This prevents a high number of voiding events to overlay each other. It is also known that the nitrogen content in the urine of dairy cows is higher during the evenings than during the day, as such, controlling the location of nighttime voiding events should be a higher priority than controlling the location of daytime voiding events. Voiding information therefore includes data indicative of a campsite which has formed, is forming, or is predicted to form.

In one embodiment, if it was determined by a routine, time or activity, that a herd was about to form a campsite or should form a campsite, then the device 20 could be operated by the controller to shift the animals 1 to the target location 8 within the paddock 2 to set up camp. The controlling may be of the entire herd at one time or at an individual animal 1 level, where it is determined that one animal 1 is likely to camp. I.e as it is determined that the animal 1 is likely to camp soon, moving the animal to a campsite target location 8. Then continue this process for all animals 1 in the herd, preferably simultaneously, or as each animal wants to move.

A target location 8 may be adjacent to a previous campsite, or it may be as far away as possible from the previous campsite target location 8. The controller is configured to manage a sequence, rank or order of target locations until all areas of a paddock 2 have been used as a campsite target location 8. By this time, the soil and pasture may have had enough time to recover for the pattern to start again, or the round length can be increased so soil/pasture has enough time to recover. In a further embodiment, the campsites may only be shifted to preferred locations 4, or shifted away from distant locations 5.

In one embodiment, the desired campsites may follow a grid 6, pattern or another system of discrete areas that are distributed in a paddock 2. These locations are described as distribution locations. The distribution locations may be pattern based about a paddock, or follow a ranked location type system described later.

Preferably the animals 1 are shifted to the campsite target location 8 that is nearest their current likely campsite location so the animals 1 are minimally disrupted, and need only walk a minimal distance. For example, a campsite will be the nearest desired campsite location to the herd's current location or the herd's likely upcoming campsite.

The distribution pattern may be for example a grid-based pattern 6 where the grid 6 is a pattern of discrete geographical areas. The areas will be the size of the assumed area of the paddock 2 that will be affected by a campsite's voiding events, for example, 5 m×5 m. So the paddock 2 will be divided into 25 m² shapes, such as circles, and these will be the desired campsite locations. The desired campsite locations preferably do not overlap with any distant locations 5.

Similar to suggesting the location of a campsite, the location of the herd during likely voiding could also be suggested to the herd. Instead of determining a campsite, the herd may be shifted to the target location 8 prior to one or more of the animals 1 likely voiding. It is likely that a majority of animals 1 would want to void in a similar time period due to routine and various factors. In one embodiment, the device(s) 20 may shift the herd to the target location 8 for the void event, then allow the herd to roam (i.e. move away from the target location 8) once the majority of animals 1 in the herd have voided. The void event may be determined as over after a time period, or may be detected as having occurred.

Moving the herd to the target location 8 (e.g a campsite target location 8) will likely be easier than moving one animal 1 to the target location 8—if the target location 8 is away from the current location of the herd. This is because cows are herd animals, and prefer to stay with the herd.

Moving the campsite to the target location 8 has the benefit over moving individual animal 1 prior to a voiding event as allowing the animal 1 to behave naturally whilst in their campsite target location 8 will be more relaxing for the animal 1. E.g the animal 1 will not need to move from a campsite target location 8 to void, and as such, they will likely be more relaxed, and their sleep patterns will not be interrupted. It is essential that the animal 1 and herd are as happy and relaxed as possible. Thus, some methods in this patent specification may be more preferable than others depending on the nature of the farming system, and the animal 1 and herd behaviours.

The record of historical or used void locations may need to be kept for a period of time. A paddock may only have animals in it for one night, and thus there may be only one campsite used in the paddock. The animals may then only return to the paddock in 30 days for example, and then it will be preferred that the target location campsite does not overlap, or is not adjacent to, the previous desired campsite/target location.

Staged Locations

Animals, such as cows, are likely to void a) once they start walking to location and b) once they arrive at a location. For example for a), upon leaving a paddock a cow is likely to void on the raceway. This is not a good location for voiding. Preferably the animal voids in the paddock at a preferable location. An example of b) is when an animal has returned from the milking shed and has arrived into the paddock.

In one embodiment, the controller determines when an animal has entered a paddock to be grazed or retained within and holds the animal at a preferable location for either a time period, or until the controller has determined that the animal has voided, or both. Once either has qualified (time, voiding, or both) then the controller will allow the animal to leave the preferable location. The controller holds, and allows the animal to leave, the preferable location via the application and withdrawal of stimulus to the animal. The controller may determine the animal has entered a paddock via activity (initiation of grazing) or location (location within the bounds of the paddock).

In another embodiment, the controller determines when an animal is going to start walking to the shed or another remote location. Prior to the animal leaving the paddock the controller will hold the animal at a preferred location within the paddock for either a time period, or until the controller has determined that the animal has voided, or both. Once either has qualified (time, voiding, or both) then the controller will allow the animal to leave the preferable location. The controller holds, and allows the animal to leave, the preferable location via the application of stimulus to the animal.

The above embodiments may be implemented at a cow level, and more preferably, at a herd level. For example, the entire herd is held at a staged location. The herd may be released from the stage location once the controller determines that the majority of the animals in the herd have voided.

The controller may also be used to direct an animal to and from the paddock. I.e as a virtual fencing controller, and/or animal directing controller.

Distribution—Shift Individual Animal

In one embodiment, the controller is configured to operate the stimulus collar to shift the individual animal 1 about the paddock 2 to distribute their void events much like campsite distribution. When the controller determines, from the voiding information, that a voiding event will occur or is occurring the animal 1 is shifted to the target location 8 based on a distribution grid 6 or pattern. In one further embodiment, the target location 8 is based on a distribution location that will avoid distant locations 5. Like campsite distribution for individual animal 1 distribution, it may also be preferable that the animal 1 is moved to the nearest target location 8 that conforms with the distribution pattern, where the location of the target location is based on a distribution location.

The distribution pattern of the distribution locations may be for example a grid-based pattern 6. The grid 6 will be broken into discrete areas of distribution locations. The void area 9 will be the size of the assumed area of the paddock 2 that will be affected by the voiding event, for example, 1 m×1 m. As such, the paddock 2 will be divided into 1 m² circles, squares or other like shape that replicates the void affected area, and these distribution locations will be the target locations 8 for each indicated void event. The size of the void area 9 may depend on many factors such as soil type, pasture type, slope, cow type, season, weather, likely urine volume, and/or likely urination time length based on historical patterns, etc.

For distribution-determined target locations 8, the knowledge/information of preferred or distant locations 5, such as geographical locations (described later) may not be necessary for the controller to operate the stimulus collar effectively. E.g in one embodiment, the controller is configured to require the knowledge of the zone or paddock 2, and a distribution location is based on no other preferred or distant locations 5. In some embodiments, the controller may also store historical location data pertaining to previous distribution locations, or locations of where previous campsites or target locations 8 were. Wherein historical location information is location information relating to the location of the animal which has occurred, and historical activity information is activity information relating to the activity of the animal which has occurred. The historical information may relate to the animal or other animals in the herd.

In further embodiments, the controller is further configured to control the stimulus collar device based on information on preferred or distant locations 5 alongside the distribution pattern and/or historical locations. Where the target location 8 is a location that depends on a geographic location, like the preferred or distant locations 5 described later, then the preferred or distant location 5 information will need to be input into the controller.

In other embodiments, the distribution location 6 does not rely on or utilise the preferred location and/or distant location. The distribution location 6 is determined purely by dividing the paddock into discrete areas, each area becoming a distribution location 6.

In a further embodiment, the distribution locations are dependent on ranked locations. Ranked locations are described in more detail below. After a first voiding event, the animal will eventually have a second or subsequent voiding event. The second or subsequent events will preferably occur at a subsequent target location, where the target location is a subsequent or different distribution location. The subsequent target locations are determined according to the distributed locations based on the ranked locations, and not a pure grid-based system or the like.

Distribution—Animal Rotation

The device 20 in one embodiment allows suggesting to the animal 1 and/or herd to turn, move, orient or re-orient themselves to a particular heading.

Where reorient or re-oriented means to change the orientation of the animal from its original or current orientation prior to receiving a stimulus. Orientation herein is generally in the form of orientation as shown by a compass heading.

To increase the void area 9, and thus distribute the nutrients, in one embodiment, during voiding, the device 20 may suggest to the animal 1 to change their heading, i.e re-orient themselves. This in turn would distribute the urine/defecation patch, i.e increase the void area 9.

Similarly, the device 20 in one embodiment allows suggesting to the animal 1 and/or herd to move (transfer) in a direction whilst voiding. To increase the void area 9, and thus distribute the nutrients, in one embodiment, during voiding, the device 20 may suggest to the animal 1 to move from their current location. This in turn would distribute the urine and increase the void area 9.

The movement may be small, as little as a single step. However, the more steps an animal takes whilst voiding, or in between portions of a voiding event, the better. This means the voiding area 9 is as great as possible, and at least larger than a void area of a stationary voiding event at one location. The step may be forward, back, diagonal, or to either side.

In a preferred embodiment, the wearable device 20 is configured to determine or detect that a voiding event is occurring, starting, or will be starting. This is achieved via receiving information from a sensing device 24, such as an activity sensing device 24. Where in one embodiment, the activity sensing device 24 comprises or is an accelerometer or IMU in the device 20, and/or located on or towards the tail of the animal. Alternatively, an accelerometer or IMU is located in an auxiliary device 30 as described later. The wearable device 20 is configured to determine a voiding event, and in the event of the processor of the wearable device 20 is configured to activate the stimulus device to stimulate (apply a moving stimulus) to the animal. For example, the processor determines voiding and activates a speaker to play an audible noise to one or both ears of the animal in an attempt to rotate or move the animal during voiding.

Upon a voiding event, the device 20 may apply the moving stimulus at multiple intervals to the animal. The objective of this is to move the animal multiple times during a voiding event. For example, should the objective be to divide a void area 9 into three smaller void areas, then the moving stimulus may be applied to the animal twice.

In one embodiment, a traditional voiding event may last for a voiding period, for example, 21 seconds. In such an example, the objective would be to move the animal twice, at seven second intervals so that the voiding period and hence void area is broken into three smaller void areas. The device 20 may detect a voiding event, wait 7 seconds, and then apply a first stimulus to move the animal, or move the animal to a second void location. Upon determination of the animal moving, or upon the end of 7 seconds, then stimulus is then applied a second time, so the animal is then moved again, or moved to a third void location. Where the void location may be very similar or close for the animal, but the aft end of the animal where the voiding occurs is sent to different locations so as to spread the void area, or at least increase the void area.

In a further embodiment, upon the device detecting a voiding event, the device 20 will apply a constant stimulus to the animal. This takes into account that the animal is slow to respond to the stimulus, compared to the length voiding period. For example, the device 20 detects a voiding event and applies a directional sound to the animal (e.g a left side speaker plays sound to the left ear), so the animal starts to turn right (if the cue is aversive) during voiding. The stimulus is continued to be applied until the end of a time period, or to the end of a void period (as detected, programmed into, or predicted by the device) of the voiding event.

Void distribution by rotating the animal 1 in some embodiments may only be done when the animal is located, for example as determined by the position sensing device and controller, in an undesirable or non-target location.

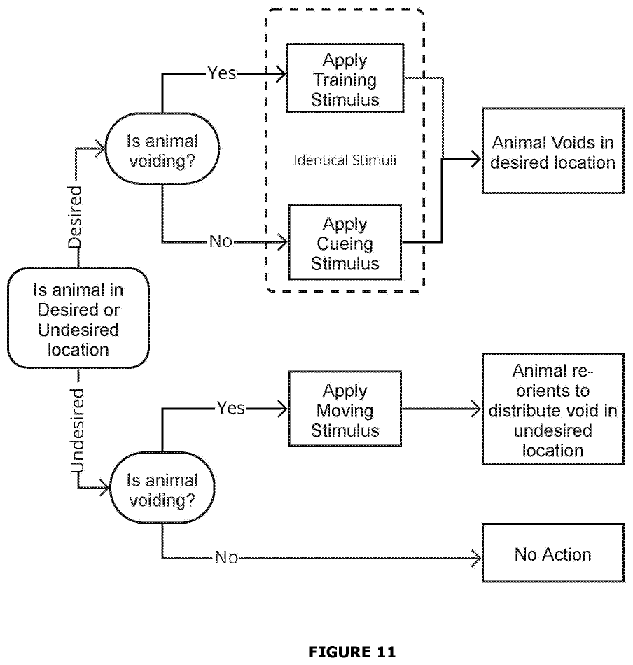

FIG. 11 shows a schematic which relates partly to void distribution. The lower half of the schematic relates to determining the location of the animal, and should the animal be determined as not being at a target location and voiding, then applying a stimulus, herein called a ‘moving stimulus’. The moving stimulus such named as utilised to attempt to move the animal as it voids. In one embodiment, the movement of the animal is turning or re-orientating as described above. If the animal is not at a target location but the animal is not going to start or not currently voiding, then no moving stimulus is applied. The upper half of FIG. 11 is discussed later under the heading ‘Training and Cueing’.

Note should be taken that the animal 1 is less likely to want to move during voiding—and the stimulus or suggestion to move should be controlled accordingly. E.g if the animal 1 is not wanting to move, or no movement of the animal 1 is determined after applying a stimulus from the device 20, whilst the animal 1 is voiding, then the device should be configured to stop applying stimulus.

Voiding herein may mean urination only, as urination has high levels of nitrogen and thus it is the highest priority to control and distribute. Further, it has been found that cows are more likely to move during urination as compared with defecation. This is relevant with the rotation/distribution method and the moving stimulus.

In one embodiment, the animal is a cow which urinates from near its tail, and re-orientating the cow moves the head of the cow around, and therefore the tail end of the cow around also, to distribute the urine patch.

Voiding in a Unique, Consistent, Area—Preferred Locations

The preferred location 4 may be one of many locations described below. The preferred locations 4 are locations where it is preferable for a herd or animal 1 to undertake a voiding event(s), or the preferred locations 4 are locations that are at least more preferable than other adjacent locations in the paddock 2.

In one embodiment, the preferred location 4 is a location that is typically unique for each paddock 2. I.e a location that is not a common trainable location on a farm. For example, the preferred location 4 is not a stand-off pad that animal 1 can be trained to locate to should they wish to void. Instead, the preferred location 4 is a location unique to every paddock 2 and may change over time. Where the time period may be between voiding events, or between times of day, week, season etc. In one embodiment, the target location and/or preferred location is not a pre-trained location known, or trained, to the animal. E.g. the animal is being guided to a location that either it has not been to before, or does not go to every time it needs to void. E.g the location is not a location that the animal has been trained to go to via pavlovian conditioning.

In one embodiment, the target location is a unique location for every voiding event. Preferably, the target location differs between some voiding events, in other embodiments the target location is the same for subsequent voiding events.

In one embodiment, the preferred location 4 is a nitrogen or other chemically deficient area that will be aided, or at least not more degraded, by receiving a voiding event. Nitrogen, phosphorus and potassium are the three major nutrients required for healthy plant growth. Cow urine contains significant amounts of both nitrogen and potassium.

In one embodiment, the preferred location 4 is an area of carbon-rich 7d soil able to mitigate the downsides of a high application of urine/nitrogen. Carbon exists in the soil in many forms, but there are three main forms: organic soil carbon; charcoal and inorganic soil carbon. All three forms can be important to soil health and fertility. Soil organic carbon (SOC) may be used as a gauge or indicator of healthy, productive soils. SOC is the carbon component of soil organic matter (SOM), material originating from biological material. Agricultural practices that retain and increase the amount of SOC in the soil may provide the double benefit of improving sustainable productivity and assisting in the reduction of atmospheric greenhouse gas. Carbon-rich soil may be determined as soil with higher SOC than surrounding soil, or above a set amount. Other factors that may influence the target location may include topsoil depth, and total organic nitrogen (TON). Preferably the preferred area is an area of high, medium, or low soil depth, TON, SOC or other factor depending on the desired outcome.

In one embodiment, the preferred location 4 is an area of ideal soil macroporosity. High values of total macroporosity and macropore surface area, and a large range of pore sizes is good for ideal soil health. Ideal soil health can better deal with urine patches.

In one embodiment, the preferred location 4 is an environmentally friendlier location than the animal's current location. In one embodiment, the controller is configured to determine the animal's current location and compare the current location to other locations in the paddock and subsequently operate the stimulus collar to move the animal on an indication of voiding to an environmentally friendlier location.

In one embodiment, the preferred location 4 is a location within the pastoral area (or bounds) of the paddock. This scenario arises when cows start moving to a new location after being settled for some time. These cows are more likely to void in this short period, for example 15 min, after rising. This is typically because an animal's blood pressure increases. If the new location is a location outside of the paddock, for example a raceway or dairy shed, then it may be preferable for the animal to void on the paddock, and not in the raceway. As such, the preferred location may be a ‘staged location’ intermediate the current and new location. The intermediate staged location may be another preferred location found within the paddock. For example, the animal awakes or rises or stops doing their current activity, and starts to move to an exit of a paddock. Prior to exit, the wearable device would suggest to the animal to stop and locate in a staged location for a period of time. Ideally during this period of time the animal will void. Once the animal has voided, or the period of time elapses, the wearable device can suggest to the animal to continue to move to its new location or target.

For the herein included embodiments, the preferred location 4 may be the same as the target location.

For the above soil-based embodiments, soil mapping of the paddock 2 would be required to determine soil characteristics. This may also be achieved via visual investigation of the soil or pasture. In such embodiments, the controller is figured to receive and store data relating to the soil characteristics and location information.

In one embodiment, the preferred location 4 is a location that is higher than the animal's 1 current location, or of a minimum height. This may be a low effort way to ensure cattle do not void in or near waterways.

Voiding Away from Known Locations

The distant location 5 may be one of the many locations described below, which are geographically based and require information of the paddock 2 or zone the animals 1 are in. The distant locations 5 are locations where it is preferable for a herd or animal 1 to be distant to or remote from when voiding. Alternatively, the distant location 5 is at least less preferable than other adjacent locations in the paddock 2.

In one embodiment, the distant location 5 is a location where should a voiding event occur there it may cause instant negative effects, for example, one or more of the following areas: waterways, wetlands, high slope areas, eroded areas, exposed soil areas, poor quality soil areas 7c, and pugged areas. Distant locations such as those described above are unlikely to change over time. Alternatively, some of these locations may change seasonally, or with changed farming practices.

The distant location 5 may also be a location where should a voiding event occur there, it may exacerbate negative effects. Such areas may be; locations of previous voidings (same animal 1 or other animals); high pasture growth areas; nitrogen or other chemically rich areas; camping locations of the herd should the camping location not already be a desired camping location.

Where voiding information includes information pertaining to previous or historical voiding events, the controller is configured to receive the information and data relating to those, to therefore determine the target location 8. For historical voiding events the controller may communicate with one or more nearby controllers located on collars, or at least receive data from nearby controllers located on collars indirectly, so that target location will be determined correctly, with up to date information. Alternatively or in combination with the above, the historical voiding events and/or related historical locations of the same animal are used by the controller as a basis for a new target desired voiding location. In the above alternate embodiment, there is no need for collars to communicate with other collars, only record and store the events of the respective animal the collar is on. Preferably only verified events, and not unverified predictions are stored as a historical event. E.g should an event be predicted, but not occur as backed up by the activity of the event, then the event should not be recorded or relied upon to be used as a historical location. In this instance, the historical locations/events should only relate to activity data of events.

The distant location 5 may also be a location that should a voiding event occur there, it would probably exacerbate issues. Such distant locations 5 may be one or more of; the area near a gate; the area near a trough 7b; the area near or under trees 7a, forestation or other shady areas, adjacent a fenceline; and low lying area. These areas are areas that animal 1 are more likely to camp, and thus have a higher concentration of voiding events.

Training and Cueing

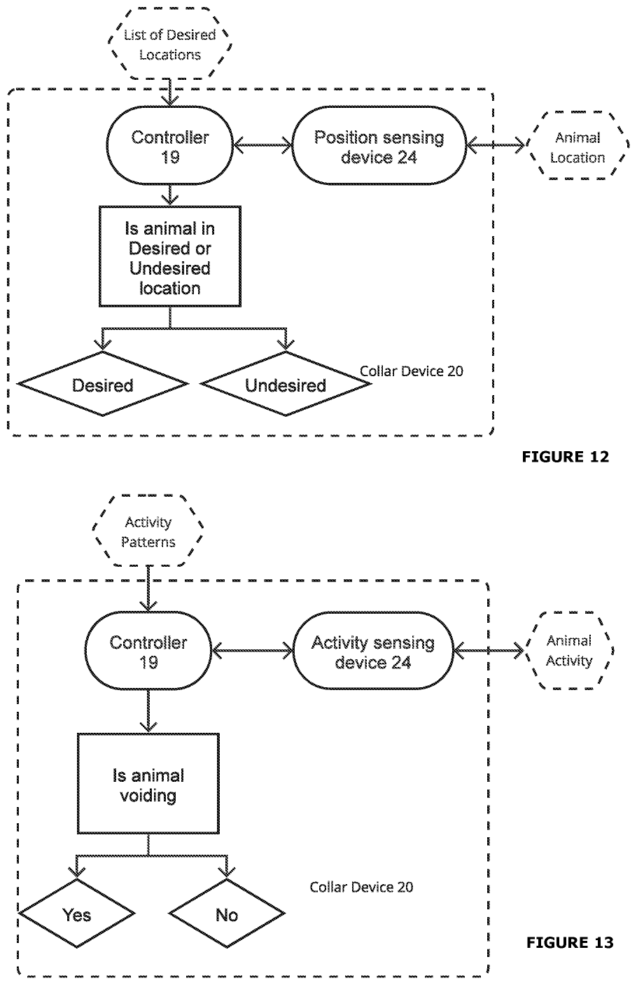

In one embodiment the device 20 is configured to condition or train an animal to void in a location, preferably a desired or target location 8. This is achieved by determining when then animal is voiding (such determined by the described methods and apparatus herein, and also shown by schematically in FIG. 13) and the stimulating the animal via the stimulus device with a stimulus known as a training stimulus when the animal is at a target location (such determined by the described methods and apparatus herein, and also shown schematically in FIG. 12). Stimulating the animal with a repeatable training stimulus when they void will condition and/or train the animal to associate the training stimulus with voiding. This may be described as classical conditioning. What is not trying to be achieved in this embodiment is to train or condition the animal to learn a stimulus and then move to a location, i.e a trained location, to void. This is difficult to do, and unreliable. It may be possible to do with one animal, but the results are less reliable as more animals are trained, for example, on 100,000+ cattle. However, training animal to void by using previous instances of the animal naturally voiding is easier to do. Further, training the animal to void at its current location is the most effective. The stimulus to void just needs to be applied when the animal is in the correct location. This is also a very relaxing method for the animal, as it doesn't need to move from its current location.

For example, should an animal enter a target location, such as a yard or an excreta collection area, and initiate voiding or void, then the device 20 is configured to determine the location and voiding status, and stimulate the animal appropriately with a training stimulus. The animal will associate said training stimulus with voiding. After this has occurred multiple times, the same stimulus (but herein called a cueing stimulus) is applied to the animal, and the animal will likely void due to receiving the stimulus that it has previously associated with its natural voiding behaviour. The stimulus is known as a cueing stimulus, as it is a stimulus to cue the animal to void.

Preferably the cueing stimulus and training stimulus are the same or substantially the same stimulus. In one embodiment, the stimulus is one of the stimulus as described herein. More particularly, the cueing stimulus and training stimulus are a non-directional stimulus, as it is not required that the animal moves. For example, the cueing stimulus and training stimulus may be the application of sound equally to both ears of the animal, or vibration to the animal. The sound may be a pattern of sound that is easily repeatable, recognisable, and/or easily audible to the animal.

The training stimulus may only be applied to the animal when it voids in the target locations, or the training stimulus may be applied to the animal every time the animal voids regardless of the location. FIG. 11 shows a decision schematic for applying the training stimulus to the animal only when the animal is in target location. In one embodiment, the training stimulus may be used at all void locations, and eventually (after more training has occurred) only be used at target locations. Doing so may increase the speed of training as all voiding events are associated with the training stimulus.

The device 20 controller is configured to apply the cueing stimulus and/or training stimulus to the animal by appropriate operation of the at least one stimulus device when the location of said animal matches a target location, and the animal has been determined as not voiding. Where the term ‘matches’ may mean that the location is fully within, partially within, at, near, or identical to the target location. The target location is preferably an area, and the animal location is preferably a specific geographic location that is a point. The target location (for any embodiment described herein) may utilise a geolocation grid system such as H3. Where the target location, or any location described herein, is matched to a hexagon.

The location of the animal sensed from the position sensing device and determined by the controller. Where the controller is configured to compare the sensed location of the animal with a list of programmed, known, or determined target locations. In one embodiment, the target locations and determination of such are as described herein. The controller may have access to memory with these locations on them. As voiding events are often short events in time, then preferably the memory is locally accessible so the controller can have access to it quickly. Accordingly, in one embodiment, the device 20 comprises locally accessible memory with target locations, and animal activity patterns relating to animal activity sensed by the activity sensing device.

The controller in one embodiment is configured to not apply the cueing and training stimuli at the same time. For example, if the animal is in a target location and has voided, the controller is configured not to then subsequently apply the training stimuli as the animal is still in the target location. A skilled person in the art will envisage there are multiple ways of doing this.

In one embodiment, the controller is configured to apply the cueing stimulus after a trigger event is received. Where the trigger event is lapsation of a time period since entering the target location, or the determination of the animal leaving the target location. This will attempt to allow the animal to void naturally, which is preferred. Only up until the last availability of time to apply, will the cueing stimulus be applied.

For example, the controller is configured to wait for the animal to void with no stimulus when entering the target location, after a period of time elapses and the animal has still not voided, a trigger event occurs, and a cueing stimulus is applied. The period of time may be preset, and/or may be based on previous behavior or routine from the particular animal or the herd of animals. The cueing stimulus in another embodiment is applied when the animal is about to leave the target location, as determined by the controller from the position of the animal sensed from the position sensing device.

In one embodiment, the device 20 is configured to both apply the moving stimulus as defined by the above description of ‘Distribution—Cow Rotation or Transfer During Voiding’ as well as the training and cueing stimulus as described in ‘Training and Cueing’. A simplified schematic of controller programming is shown in FIG. 11.

Algorithm

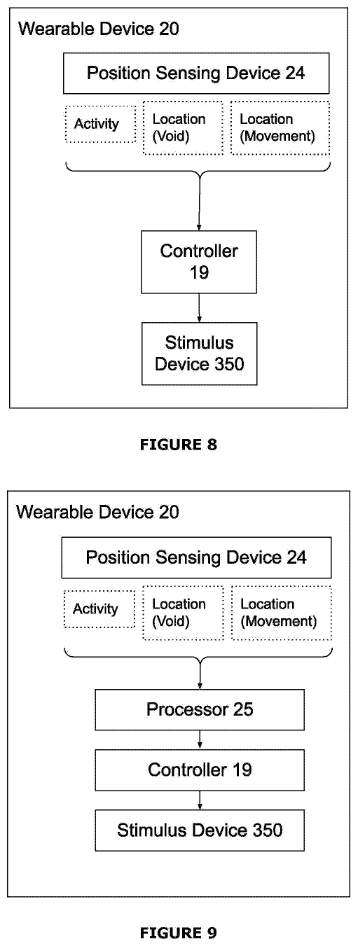

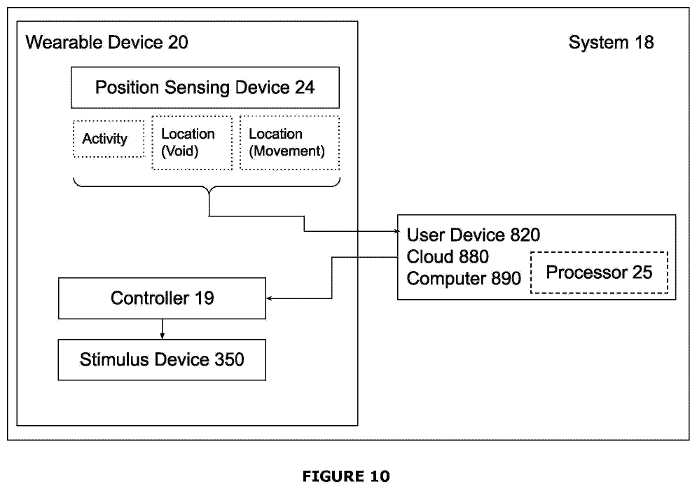

To determine the target location 8, the controller requires location information regarding one or more; a paddock 2 (boundaries); locations (geographical locations/information, distant locations 5, preferred locations 4, historical locations, animal locations) for the controller to operate the and device 20 appropriately and suggest the target location 8 to the animal 1. The location information can be used for both determining the target location (location (void) as shown in FIGS. 8-10), as well as aiding in guiding/moving the animal to ensure it reaches the target location (location (movement) as shown in FIGS. 8-10). I.e. to control the stimuli according to the animal.

In some embodiments, the controller is configured to determine what the target locations 8 are and thereby determine a priority or preference for each location. To achieve this, the controller requires the weightings given to the various locations (geographical locations/information, distant locations 5, preferred locations 4, historical locations). E.g to be configured to decide where the target location 8 will be, given the many options available and to make the appropriate trade-offs.

Further geographic information, such as those relating to the geographic preferred and distant locations 5 may be input by the user, or maybe be determined by downloading information directly from other sources, information such as terrain maps, waterway maps, soil maps, slope maps, other maps, farm maps, weather forecasts or history, camera data, satellite imagery, irrigation data, fertiliser input data, etc.

The final information to be able to be received or determined by the system is the animal information that is dependent on the animal 1 and/or herd. The animal information may be historical, live, or forecasted. Further, the animal information may relate to the animal 1 that is to be suggested to the target location 8, alternatively or in combination, the animal information may relate to other animals in the herd with the animal 1, or other animals that have been in the same paddock 2 that the animal 1 is in, or is to go in, or the target location 8 will be in.

In one embodiment, the controller is configured to determine the best option for the target location 8 based on the information (location, geographic, animal) received. For example, if a preferred location 4 is on carbon-rich soil, but the carbon-rich soil is located under a tree 7a (which is potentially classified as a distant location 5), then if the trade-off is acceptable, the target location 8 can be under the tree 7a on the carbon-rich soil. However, if under the tree 7a there is a campsite or pugged soil, then an alternative target location 8 may need to be determined. It may be up to the user or programmer to decide what features should be weighted more or less than others, depending on the desired outcome, inputs and the system.

Both the distant areas and preferable areas are weighted, and given a desirability ranking as a ranked location.

For example a trough, which is considered a poor choice for voiding, may have a high Distant weighting of −8. Carbon rich soil, which is considered a good choice for voiding has a preferable weighting of 8. If a location has both a trough and carbon rich soil, then its target location ranking (or aka desirability ranking) will change considering both factors. The target location may be any location that has a positive desirability ranking; a desirability ranking over a set ranking (for example, positive, over 0, or over 5); or selected from the top of the desirability ranking, and if further non-colocatory target locations are required, moving down the desirability rankings. The ranked locations over a set ranking, may be determined as an environmentally friendly location. Preferably, the animal 1 is guided to move to the target location which has been determined as more environmentally friendly that the animal's current location, once an indication of voiding has been determined. An example of ranked locations are shown below.

| | | | Ranked Location |
|---|---|---|---|
| | Distant | Preferable | (desirability |
| Features at a location | Weighting | Weighting | ranking) |
| Trough | −8 | 0 | −8 |
| Carbon Rich Soil | 0 | 8 | 8 |
| Trough & Carbon Rich Soil | −8 | 5 | −3 |
| Historical voiding location | −4 | 0 | −4 |
| Waterway | −10 | 0 | −10 |
| Historical Voiding Location | −9 | 0 | −9 |

For Distribution locations, the ranked locations may be used to order the priority of distribution locations. For example, the first distribution location may be (using the above table as an example) Carbon Rich locations, then Trough and Carbon Rich soil, all the way down to the lowest ranked location. In some embodiments, it may be decided that the distributed locations will not include any ranked location with a ranked location ranking less than −9. And instead, choosing to reuse a previous distributed location that has already been voided on, i.e a historical location. In the alternative, historical locations may be given a ranking of −9 or above so they are ranked above waterways.

Preferably all areas of a paddock have a ranked location ranking. This gives the most possible location options for the system or device to suggest the best movements for an animal, that minimise animal disruption. There may be further models and algorithms utilised which provide an optimum target location based on the ranked locations, weightings, distance to travel between the current location and target location, environmental factors, farm factors, animal factors etc. For example, a closer, but lower ranked location may be suggested to the animal over a further away but higher ranked location. This weighting for closer locations may increase should it be a hot day as it is less desirable to move an animal further away from its current location. Likewise, closer target locations may be utilised should it be determined depending on the proximity to a voiding event. For example, a nearby target location is utilised should it be determined that an animal will void imminently, and a further away, but higher ranked location is used as the target location if it is determined that the animal will void soon but not imminently. Preferably, a number of methods of the above examples may be utilised at once, and interact with each other.

The above determinations and calculations are determined by the controller, as may be implemented by a processor 25. Where the processor 25 may be on or off the wearable device. The controller can assign weightings to the locations.

The historical locations/events may affect in real-time, or delayed time, the desirability rankings and hence the distributed locations. For example, should an animal be moving towards a target location but another animal in the herd void at the same target location, another target location for the animal yet to void will be determined and the guidance of the animal updated.

Determining Voiding Information

As stated previously, voiding information relates to when or if the animal 1 is going to void. To determine this, the controller may utilise the animal information. The animal information can be based on one or many variables, some relating to animal location and/or animal activity. In addition, the animal information may also include timestamps relating to when the activity occurred or when the location information was created. The animal information may be historical, current, or a prediction of a future location or activity. The animal information can also be used by the controller to determine the target locations 8. The animal information may be used, or be described as, a routine or animal routine.

In one embodiment, forecasting of an animal voiding is based on a number of factors, and the forecast will likely have an associated probability of the likelihood of occurring. The more factors that point towards a voiding event occurring will alter the probability.

Animal information used to determine a voiding event may be, or relate to:
a. If the animal 1 is forming, or going to form, a campsite,
b. Time of day. E.g animals 1 may prefer to void at certain times of the day. These times may be based on the position of the sun or other routines.
c. The cumulative time after milking. E.g a cow may void when they get wet feet before they enter the milking shed, and as such if the frequency of voiding is known, the next voiding event could be predicted.
d. The cumulative time after drinking. E.g animals 1 will tend to void after ingesting liquid, and thus a likely time after drinking can be determined.
e. Time spent at the trough. E.g if animals 1 spend more time at the tough, then the likelihood of a subsequent void event may increase. This may include activity and/or location information.
f. The cumulative time of grazing. E.g animals 1 will tend to void after ingesting an amount of grass.
g. Pasture intake, preferably determined by grazing time.
h. After walking. E.g after an animal 1 has walked to a location, and it can subsequently relax, it may be more likely to void. This may include activity and/or location information.
i. If crossing through a wet area. E.g. cows are likely to void if they get wet feet. This may include activity and/or location information.
j. Frequency of expected voiding. E.g how often on average an, or the, animal 1 voids per day.

Further animal information relates to the past, current, or future activity performed by animal 1 or predicted to be performed by animal 1. As more data from an animal is recorded, the animal information and predictions can get more accurate.

Animal activity information that may relate to an animal voiding soon or imminently may be one or more of the following:
i. High activity. E.g the animal 1 is moving quickly, or pacing, or other unusual activity.
ii. Camping (in combination with location). When cows group in a campsite, they are more likely to void.

One type of animal activity information that may relate to an animal 1 voiding starting or occurring: 1) Arching back, and/or downward pitched neck. This may be in combination with location, such as the animal 1 being stationary, and 2) Having a particular Overall Dynamic Body Acceleration (ODBA) and neck pitch.

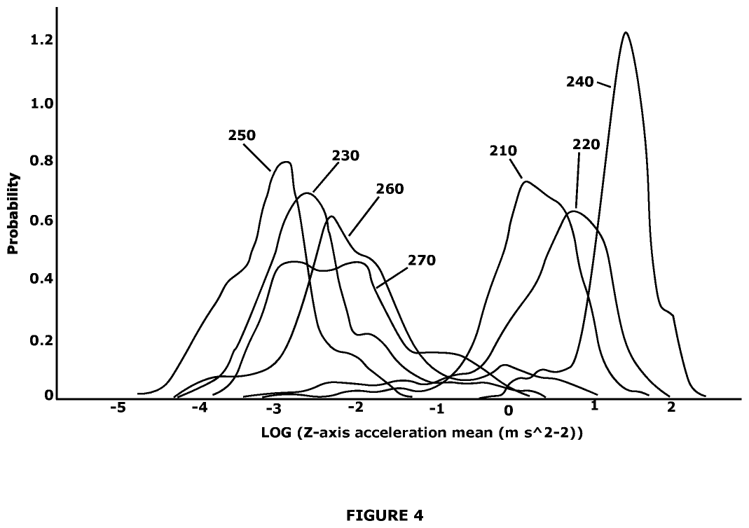

E.g for urination, it was found cows had on average an OBDA of 1.492 and an average pitch of −11.95. An example of different activity measurements with OBDA and pitch is shown in FIG. 3 for reference. For defecation, cows were found on average to have an ODBA of 2.447 and an average neck pitch of −25.90. These numbers are specific examples only and will depend on the device 20 used, and its location on the animal 1. In this example, the device 20 is a neck located collar, and the pitch, therefore, relates to the cow's neck. There will be a range/tolerance of values that hold true for an activity for an animal 1. The numbers may be different for different cows/herds, however, analysis using a consistent device 20 will soon be able to be matched up after data analysis and data labelling. In a similar fashion, FIG. 4 shows the log of the mean acceleration of the collar and hence cow, graphed vs the likelihood probability of the activity being accurate/true, for various activities such as grazing, walking, lying, running, sleeping, standing, and urinating. The urination data curve is shown by the thick black line.

Other inputs can also be used by the controller to affect the probability of the predicted forecasted voiding event. The other inputs may be input by a user to the controller, or the controller may retrieve or receive the other inputs from other sources. The other inputs can also be used to determine the target locations 8.
1. Feed type. E.g the dry matter content, or type of feed. For example, plantain makes cows void more compared to grass.
2. Seasons. E.g in hot seasons cows may drink more and therefore void more. Different seasons also relate to different feed crops, as well as different animal 1 behaviour, e.g milking, drying off, in heat, calving etc.
3. Temperature. E.g. Hot days or cold days will affect voiding events.
4. Genetics. E.g the breed of animal 1 will affect how often or much they void.
5. Farm type or System. This can be the type of system the farm is running at the time, such as strip grazing, crop grazing, once or twice day milking, beef, etc.

The frequency, patterns and behaviours prior to and when animals 1 void are able to be learnt as more data and information is collected and cross-referenced, at a farm, herd, and/or animal level. A routine of the animal may be determined to predict voiding events. The routine may be determined from one or more of
1. current location information of the animal;
2. current activity information of the animal;
3. historical location information of the animal;
4. historical activity information of the animal; and
5. other inputs as described above.

The routine may be determined by the controller. The routine, target locations or any other determinations may be calculated using machine learning, regression models etc.

Physical Requirements of the Device

To determine the animal location and animal activity requires detection of movement such as angular position and/or 25 location of the animal 1. To determine animal activity requires detection of movement such as the angular position of the animal 1 or part of the animal 1. Movement detection is achieved by at least one sensing device 24, such as a position or activity sensing device. Such sensing device 24 may be, or may comprise, movement devices comprising an angular position sensor such as IMU, gyroscope, or location sensing device 24 such as navigation sensors GPS or LPS. In one embodiment, the position sensing device is one in the same as the activity sensing device. In other embodiments, the location sensing device is a movement based device such as an accelerometer, IMU, or gyroscope. Wherein the location sensing device is a GPS or LPS. In most cases, a system will comprise both IMU and GPS, and use them in combination with each other. Herein, a sensing device is used to encompass both position sensing device and activity sensing device.

More preferably, solely the location information is used to determine the location of the animal 1. The location information of animal 1 is recorded at a frequency over a period of time. The location information is then stored or communicated to the computer 890, device 830, or cloud server 880. The location information (including the activity information if taken) is communicated from the collar by connecting the collar with the Internet 865 via WiFi, Bluetooth, or cell transmissions such as 3G, 4G, LTE etc. The software application may access the information (animal location/activity information) stored on a remote server, such as cloud server 880. The information contained in the cloud server 880 can also be accessed by a remote processor 25 of a computing device, such as a PC 890 or a mobile device 830, via a connection through the Internet 865.

In a more specific example, a user 820 may use a software application (such as mobile app) on a user device such as a mobile device 830, which includes, or can receive the information from receivers capable of detecting signals originating from GPS satellites 840, WiFi repeater/booster stations 850, and one or more cell towers 860, as well as signal 870 originating from a collar 20 carried by the animal 1. The device 830,890 can then analyse and determine the animal location information and animal activity information, and use this information to aid in determining the target location 8.

The device 830,890 or cloud server 880 may comprise the processor 25 that determines or calculates the target locations, and/or distributed locations.

Activity

Detection of the angular position of animal 1 can provide an indication of movement in an up and down direction as well as in a left or right direction. The angular position is recorded as at least one position value by at least one sensing device 24. In an embodiment where the wearable device 20 is a collar to be work on the neck of the animal 1, the movement device senses the head movement of an animal 1 such as the animal 1 in a field, then movement in up and down direction can indicate that the animal 1 is eating food from a location lower than its normal standing and resting condition. The head and neck of the animal 1 will be moving up and down relatively more frequently than if the animal 1 was merely loafing (resting). Similarly, movement in a left and right direction indicates that the animal 1 is turning/heading to either a left or a right direction. Other activity types may also be determined by the processor 25 (or later in by the PC or mobile device) on the basis of a measured/sensed position value(s) (angular position and/or location value) and comparing such measured/sensed position value(s) with a predetermined value(s) relating to the position(s). If the measured position value is within, the same, or is substantially the same as the predetermined value(s), it may be determined that the position value(s) of the animal 1 is normal and the animal 1 is grazing. However, if the measured/sensed position value(s) fall below or substantially below or exceeds or substantially exceeds the threshold pre-determined value(s), it may be determined that the angular position is different, and the animal 1 is either undertaking another activity such as lying, running, sleeping, standing, defecating or urinating. Each activity type has a unique set of movement patterns that can be identified by machine learning algorithms. FIG. 4 shows movement information which has been grouped into distinct groups depending on the z-axis acceleration movement information (log of the z-axis acceleration is graphed) and the likely probability that the activity is correct. Similarly, FIG. 3 shows activity types and their average OBDA and neck pitch. In FIG. 8, Reference numeral 210 corresponds to grazing, reference numeral 220 corresponds to walking, reference numeral 230 corresponds to lying, reference numeral 240 corresponds to running, reference numeral 250 corresponds to sleeping, reference numeral 260 corresponds to standing and reference numeral 270 corresponds to urinating.

The ‘relation’ between a sensor value and the animal 1 behaviour is not always ‘human describable’. Hence machine learning can help in this area. But there are some clear and simple relationships between sensor values and animal behaviour that we know of; pitch indicates when a cow is grazing (head goes down); roll indicates when a cow is lying on her side; Overall Dynamic Body Acceleration (ODBA) indicates how active a cow is. For example, running, charging, walking, mounting are behaviours where the cow is very active.

In terms of urinating/defecating behaviour, it is difficult to know when a cow is urinating/defecating based on sensor data captured by a collar on the neck of an animal 1. However, a lot of activity types can be excluded. For example, based on Roll and ODBA it can be determined when a cow is running, lying on her side, or mounting, and hence there is a strong probability that it is not to be urinating/defecating. Using this information, historical and current locations of void events can be created of where a cow has the highest probability of having voided.

Alternatively, the device 20, or a further, wearable device 30 may be attached to other limbs of an animal 1 for more accurate or different sensor data to be collected. This embodiment is described later. F

The user 820 can input their desired variables such as the zone/paddock 2 boundaries 3, other inputs, etc into the device 830, or PC 890 for example. The device 830,890 is also configured to receive one or both of the geographical information and animal information.

From one or more of these three inputs, the device 830,890 can determine the target location 8 that the animal 1 or herd should locate to, or move accordingly. The device 830,890 is configured to send a signal or instruction to the wearable device 20 relating to the target location 8. The wearable device 20 can then suggest to the animal 1 (or herd, where appropriate) to move to the target location 8 if the animal 1 is not already present at the target location 8. The suggestion of movement by the wearable device 20 is via the stimulus as described previously.

The above features are used to enable a system 18 to achieve the desired function of the invention.

The animal 1 in one embodiment is a bovidae animal 1, such as a dairy cow 1 or beef animal 1. The animal 1 may be other types of bovidae such as oxen, goats, sheep, bison, and buffalo. The present invention could be used with any animal 1 that is located on pasture or crops, or where voiding activity is desired to be distributed or shifted, such as dogs or other pets.

In one embodiment, the device 20 is loaded with, or can communicate with the device 830,880,890 to access, maps of the paddock 2 with all the locations and information available. For example, a zone map may be accessed with areas of interest (distant locations 5 to avoid, preferable locations 4 to void in, preferred distribution locations that the device 20 can use to make its own up to date choices, or send data to the map to update the map. I.e the collar may add a void event to a common map which other devices 20 in the herd can then access to determine future choices/target locations. All devices 20 in the herd in one embodiment can update a common map relating to a paddock 2 that the devices 20 are in.

Processor

In order for the animal to move to the target location, a controller configured to operate the wearable device (also herein called a collar) must determine or be supplied with the target location. As such, the controller must determine at least one or more of the distributed location, animal activity, target location, and any other used variables to output to the stimulus device 350 a stimulus or stimuli to suggest movement to the animal to the target location. The controller itself may determine at least one or more of the target location; distributed location; and void information. In other embodiments, at least one or more of the target location; distributed location; and void information are determined off the wearable device.

In other embodiments, the controller 19 onboard the wearable device receives a signal or control from off-collar (off-wearable device) relating to the target location; distributed location; and void information.

In another embodiment, the determination of the target location; distributed location; and void information may come from an off-collar processor 25 located off the collar. but part of the system. The off-collar processor 25 may be located in the cloud, a remote PC, or the user's device etc.

In other embodiments, the wearable device comprises the processor 25. In further embodiments, determination of the above information to be determined is on the processor 25 on the wearable device, or on both the off-collar and on-collar processors 25. Within this specification, where calculations or determinations are required, it is assumed they are done by a processor 25 which is selected from one or more of, or shared between two or more of; an on-collar processor 25, an off-collar processor 25, and the controller 19. Likewise, some information may be determined by one processor 25, and other information may be determined by a different processor 25. For example, Activity and Location information that is used to determine the likelihood of voiding may be processed off-collar, where location information used for determining animal position for moving may be determined on-collar.

As used herein, the term processor may mean the on-collar processor 25, off-collar processor 25, or computer that is part of the controller.

The controller 19 is operatively connected to the at least one sensing device 24 and is programmed to read and compare the at least one position value with at least one predetermined value relating to the at least one position value for determining if at least one control action is required, the at least one control action being transmitting of at least one control signal to the at least one stimulus device 350.

In some instances, the controller determines the animal activity from the movement information and values received from the sensing device 24. E.g if up and down head movement is received, it may be determined that the animal activity is grazing.

The device preferably comprises the controller 19. The controller 19 is operatively connected to the sensing device 24, which in this case may be programmed to read the angular position value detected by the sensing device 24 as a position value(s) and compare such angular position value(s) (position value(s)) with a predetermined value(s) relating to position in order to determine if one or more control action is required.

If the controller 19 determines that a control action is required (i.e. to move the animal from a current location to a different location), then the controller 19 is configured to transmit at least one control signal to one or more stimulus devices that is able to be sensed by the animal. The stimulus device may be in a form of an apparatus that is separate but is operatively connected to at least one controller 19 of the apparatus 20 and may be adapted to be carried (worn) by the animal and when the control signal is received, the stimulus device is configured to be activated in order to administer one or more form of stimulus to the animal. The stimulus may be of any form that could be sensed by an animal such as but not limited to electric current such as electric shock (preferably of variable magnitude), sound (preferably of variable volume and/or frequency), vibration (preferably of variable strength or intensity and/or frequency) or a combination thereof.

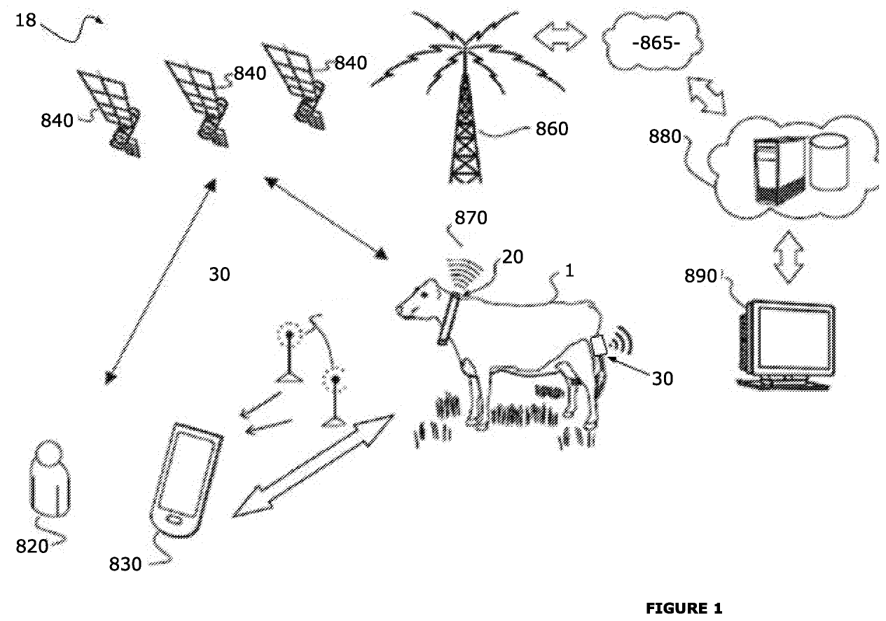

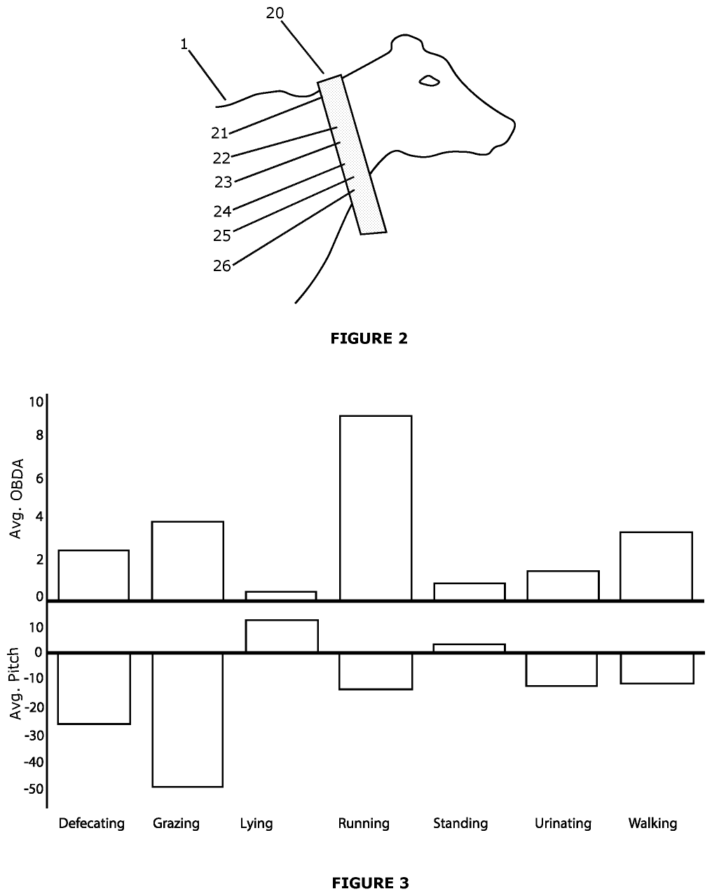

Instead of the controller 19 determining if a control action is required, the controller 19 may optionally be connected to a remote processor (see processor of PC 890 in FIG. 1) or a remote server (see cloud server 880 in FIG. 1) or a user device (see mobile device 830 in FIG. 1) comprising a user interface and is configured to perform the control action on the basis of a control command received from the remote processor. Preferably, the remote processor is operatively connected to or is part of the user device such as a smartphone, PDA, PC, laptop or many other suitable user devices. Similarly, the remote server may be operatively connected to the user device (such as PC 890 of FIG. 8 or processor of PC 890 of FIG. 8). More preferably, the control command is sent by the user from the user interface of the user device.

The sensing device 24 could be a position sensing device 24 carried by an animal or be in electronic communication with a position sensing device 24 that may be carried by an animal. The location may be the location relative to datum. The location may be location relative to global position. The position sensing device 24 may be configured to detect the longitude, latitude and/or horizontal position of at least part of the animal.

Position Sensing System

Preferred embodiments include a position sensing device or system, or interface with a position sensing system which acts to locate animals and locations of interest within a consistent geographical frame of reference. The position sensing system operates to provide animal location data. The position sensing system further operates to provide a reference to any one or more locations. The position sensing system further operates to provide a relative frame of reference to the animal location data and the one or more locations.

The position sensing system also acts to determine the activity of the animal. Where the activity is any movement of the animal or part of the animal.

The position sensing device may therefore determine or detect both location data and activity data. Or further, the position sensing device may comprise both a location sensing device and activity sensing device. However both devices may be utilised for both location and activity. For example, a location sensing device is a GPS used to determine location, but the GPS may also be used to determine if the animal activity is moving quickly or walking by determining multiple locations sensed by the GPS. Likewise, the activity sensing device may comprise an accelerometer used to determine acceleration of the animal, but it also may be used to make GPS locations more accurate. The position sensing device is encompassing for both activity and location.

In preferred embodiments, the controller is also configured to receive or determine location information as described above, including the one or more locations of interest, such as voiding target locations, relative to the frame of reference provided by the position sensing system.

In some embodiments, the position sensing system is a local positioning system (LPS) or global positioning system (GPS). Each of the local or global positioning systems include one or more transmitter components which output location reference data, and a receiver component which receives the location reference data and determines a location of the receiver component relative to the reference data. For example, LPS transmitters may include one or more beacons such as cellular base stations, Wi-Fi access points, and radio broadcast towers to compute the position of the receiver/sensor.

Locating position information of an object with a GPS position sensor is previously known in the art and need not be described in much detail. Basically, a GPS sensor/receiver may calculate its position by precisely timing the signals sent by GPS satellites high above the Earth. Each satellite may continually transmit messages that may include the time the message was transmitted, precise orbital information (the ephemeris), the general system health, and rough orbits of all GPS satellites (the almanac). The GPS sensor/receiver may use the messages it receives to determine the transit time of each message and compute the distance to each satellite. These distances along with the satellites' locations may be used with the possible aid of trilateration, depending on which algorithm is used, to compute the position of the receiver/sensor, and therefore the animal attached to the receiver/sensor.

In preferred embodiments, animal location data is derived from a positioning system receiver attached to a collar worn by an animal, and is configured to communicate LPS or GPS data to the controller to thereby indicate the animal location data.

In some embodiments, the controller is configured to determine the location of each animal wearing a collar. In such embodiments, the controller is configured to receive location data from a position sensing receiver located on each collar. For a herd of animals, the controller may thereby determine the location of each animal wearing a collar which includes a position sensing receiver.

In some embodiments, the controller is configured to receive location data pertaining to one or more locations of interest within the geographical frame of reference.

In some embodiments, the controller is configured to determine if a control action is required by comparing at least one received position with other location data.

The animal location data may include longitude, latitude, altitude, and/or horizontal position or coordinate data pertaining to the animal.

Animal Stimulus Collar

In a preferred embodiment, the animal collar device 20 comprises two speakers 350 (350a, 350a′) the first speaker 350a may be on the left-hand side and is adapted to be to be positioned more proximal the left ear of the animal 400 and a second speaker 350a′ may be on the right-hand side and is adapted to be positioned more proximal the right ear of the animal 400. Both the speakers 350a, 350a′ may be capable of transmitting sound independently and in concert with the other. Instead of having speakers 350a, 350a′ on two sides, it may be possible that the device 20 only comprises one speaker(s) on one side, or in the centre position of the collar 20. Each of the speakers being configured to be positioned proximal to an ear for the animal to generate the at least one first stimulus in a form of an audible sound to the animal when the collar is secured to the animal, wherein at least one of the speakers is to contact a left side of the neck of the animal and at least another one of the speakers is to contact a right side of the neck of the animal, the respective speakers configured to play sound to the left and right ears of the animal.

In this example of a preferred embodiment, it is shown that there are two vibrators 350b, 350b′, the first vibrator 350b is on the left-hand side and the second vibrator 350 b′ is on the right-hand side. Both the vibrators 350b 350b′ are capable of vibrating independently and in concert with the other. Instead of having vibrators 350b, 350b′ on two sides, it may be possible that the device 20 only comprises vibrator(s) on one side, or in the centre position of the device 20.

The stimulus device may comprise electrode(s) 350c, 350b′ for contacting the neck of the animal 1 when the device 20 is secured around the neck of the animal to provide an electric current or shock to the animal. It may be possible that the collar 300 comprises either speaker(s) 350a, 350a′, vibrator(s) 350b, 350b′ or electrode(s) 350c, 350c′. It may also be possible that, the collar comprises either speaker(s) 350a, 350a′ and vibrator(s) 350b, 350b′, or speaker(s) 350a, 350a′ and electrode(s) 350c, 350c′, or vibrator(s), 350b, 350b′ and electrode(s) 350c, 350c′.

In one embodiment, the stimulus device is configured to administer a stimulus in the form of a sound to the left ear of the animal to suggest movement of the animal to the right, and administer a stimulus in the form of a sound to the right ear of the animal to suggest movement of the animal to the left.

The administering of stimuli to the animal will continue until the animal has reached the target location, and/or the animal has voided. The sensing device 24 will continue to use the animal location information to determine whether or not the animal has reached the target location, and/or whether further stimulus or stimuli need to be applied.

FIGS. 8-10 show the sensing device as sensing the activity, location void and location movement. The location formation may be the same information but used for different purposes. I.e the location void may be used to determine routines and enable the prediction of a void event, and location movement may be used to enable guiding or moving an animal to the target location.

In one embodiment, the wearable device also allows for virtual fencing of the animal. Where virtual fencing is as described in WO2019180624.

Tail Sensor

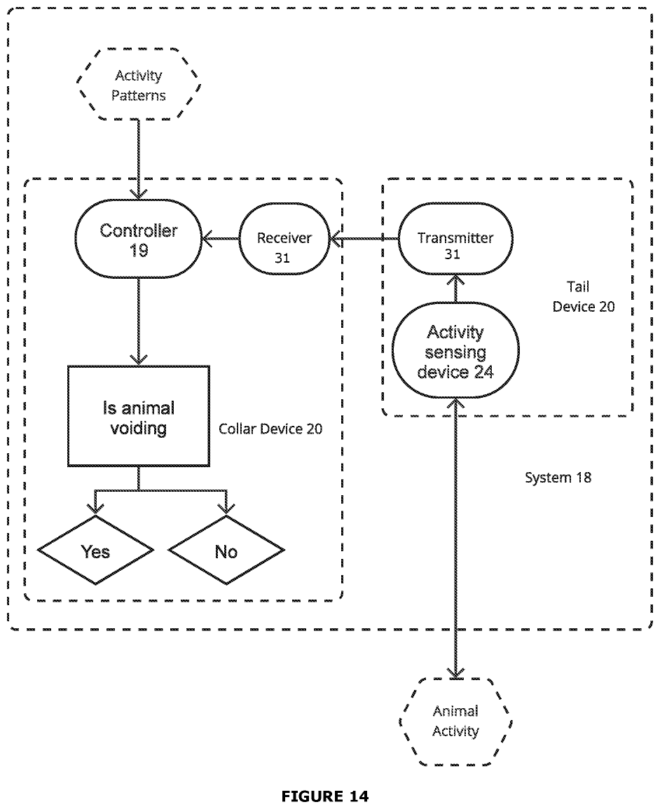

In one embodiment, the device 20, or a further, a wearable device 30 is attached to other limbs or parts of an animal 1 for more accurate or different sensor data to be collected. In one embodiment, the tail device 20 is distinct and separate from the collar device. However, the collar device 30 is as previously described herein as the wearable device, and the tail device 20 may be described as part of the wearable device 20 but is not physically connected to the collar wearable device. A simplified schematic flow process is shown in FIG. 14 showing the tail device 30 sensing animal activity and sending said data to the collar device 20. The tail device 30 may have a controller or processor, not shown in FIG. 14.

For example, a wearable device 30 to be worn on the tail of the animal 1 is configured to collect more accurate data on urination activity compared to a neck-worn device, as the tail of a cow often moves in a particular way when the cow is urinating and/or defecating. This may also be true of many other animals, especially female animals which tend to move their tails in a repeatable manner each time they void. In particular, cattle animals such as female cattle.

The detection of voiding can initially be determined by labelling the voiding events manually, via camera and matching them with the sensor data recorded and/or transmitted from the device 20,30.

Voiding detection can be triggered when device 20 or device 30 (e.g the controller) identifies particular data patterns, i.e pattern recognition, that represent a voiding event. In particular, urination events of female cattle can be identified by the controller by a particular set of tail movements sensed by the activity sensing device. A skilled person in the art will understand how to sense, record and determine such movements using machine learning and/or pattern recognition.

In one embodiment, device 30 is attached around the tail, on the tail, or near the tail. For example, device 30 is a band to be worn about the tail, located on the tail, spine, rump, or hips, legs of the animal. An example of a tail-mounted sensor that utilises an accelerometer or inertial measurement unit is the MooCall™ device, which has a related PCT application WO2017211473A1 for a method of providing an indication of the oncoming parturition.

In one embodiment, the system comprises an auxiliary wearable device 30 as shown in FIG. 1. The auxiliary wearable device 30 is configured to at least sense and transmit motion data of the mounting location (i.e. the tail) to the wearable device 20. The auxiliary wearable device 30 preferably comprises an activity sensing device such as an IMU or accelerometer to record the motion data/activity data.

Each activity type, such as voiding, has a unique set of movement patterns that can be recorded by the activity sensing device and identified by machine learning algorithms.

Preferably the tail device 30 comprises or houses a position sensing device, in particular an activity sensing device. Said device in one embodiment is an accelerometer. In a further embodiment, the accelerometer is an interrupt based accelerometer. Said interrupt based accelerometer will allow the tail device 20 to use as little power as required, by waking up when motion is detected.

The auxiliary wearable device 30 preferably comprises a transmitter 31 to send the activity sensing device data to the wearable device 20. Preferably the collar device and tail device are configured to communicate to each other at least in one direction from the tail device to the collar device, preferably wirelessly. However in other embodiments communication transmission goes both ways. The communication methods and protocols are those as discussed herein with the wearable device 20. For example, the devices 20,30 comprise one or more of the following data transmission devices utilising; bluetooth, BLE, LoRa, WiFi, NFC or other like protocol. The data transmission devices being transmitters 31, receivers 31, or transceivers 31 configured to allow communication between the devices 20,30. In one embodiment, the tail device comprises solely a Bluetooth low energy (BLE) transmitter.

The collar 20 accordingly will need a receiver to listen for the tail device 30. The receiver on the collar 20, is preferably a BLE receiver. The receiver 31 is configured to ‘listen’ for the tail device transmitter. In one embodiment the receiver 31 is configured to listen for a short period of time, intermittently. For example, 50 ms every 10 seconds. This time period will allow the collar 20 controller to not miss any urination events, as often urination events are at least 20 seconds long. It is envisaged the listening time the how often the receiver listens can be modified depending on animal characteristics and power requirements of one of both devices 20,30.

As device 30 sends the data to device 20 for action (stimulation if required) or processing, device 30 can be relatively low-powered as it does not need to stimulate the animal or process large amounts of data. In one embodiment, device 30 can solely determine if a voiding event is occurring, and is configured to send a simple message to device 20. The device 20 can then determine what to do with said acknowledgement information. In other embodiments, the device 30 purely sends the sensor data, such as the animal activity sensing device activity data, to the device 20. The device 20 can then determine if voiding is initiating or occurring. The device 20 determines such by utilising the controller as discussed herein.

In one embodiment, the device 30 also comprises a tail controller, similar to the device 20 controller, to receive said sensed activity data from the animal activity sensing device, and send it via a transmitter 31 to the device 20. The activity data may be processed accordingly to allow efficient packing and sending of the data. The tail controller in one embodiment determines from the sensed data that a voiding event is initiating or occurring, and informs the collar located controller accordingly. The flow diagram shown in FIG. 14 does not show the controller located with the tail device 20. The controller in the FIG. 14 embodiment would receive the activity sensing device 24 data, determine if a voiding event is initiating or occurring, instruct the transmitter 31 to transmit to send the appropriate message to the collar device 20 receiver.

A like controller located in the collar device 20 is configured to receive the tail device 30 message; and operate the at least one stimulus device to administer the at least one stimulus to the animal if appropriate.

In one embodiment, device 20 does not have a photovoltaic panel, as it uses minimal power and a battery charge is sufficient for the lifecycle of the device. The device 30 comprises a swappable, long life, or chargeable battery. In other embodiments, device 30 has a photovoltaic panel to charge the battery.

In particular, the use of a tail-mounted wearable device 30 is used with the method described above under the subtitle ‘Distribution—Cow Rotation or Transfer During Voiding’. Where the tail sensor 30 enables the collar 20 to determine a voiding event is occurring, and to stimulate the animal to rotate whilst they void, thereby increasing the void area.

User Interface

In some embodiments, the controller comprises a user interface that is configured to interface with one or more user inputs that are operable to allow the entry of data, such as location information data relating to one or more locations of voiding targets, waterways, fences or similar as previously discussed in detail. The user interface may include any one or more peripheral computing devices operable to facilitate data input. The user interface may further include a display device operable for the display of map data and user data input.

In some embodiments, the controller is configured to display map data to a user and allow identification and entry of location information by the user. The map data is preferably displayed visually with the location information overlaid on the map data for ease of visual reference. Animal position data and location data may therefore comprise map data and may further be displayed visually as data points overlaid on map data. Map data and location information may be input to the controller in the form of data such as coordinates based on a geographical reference.

For example, in some embodiments, visual information displayed by the controller may include a map of a geographical area where one or more animals (wearing stimulus collars) are located. The one or more animals may further be displayed by a visual indication overlaid with the geographical information. Further, the controller is configured to receive data relating to one or more voiding target locations within the geographical area. The controller may then operate to control the stimulus collar to guide an animal to the target location based on any suitable criteria as discussed in detail above.

In some embodiments, voiding target locations comprise data pertaining to the weighting factor, rank, or other factors as described above. Accordingly, in some embodiments, the user interface is configured to allow the entry of such weighting or rank data based assigned to any one or more locations of interest within the geographical reference, and the controller is configured to receive such data from the user interface.

In one exemplary embodiment, the user interface displays geographical information and allows the selection of voiding target locations from the displayed geographical information. In other exemplary embodiments, the controller is configured to receive voiding target coordinate information based on the geographical frame of reference, such as a GPS or LPS coordinate and optional weighting data. In other exemplary embodiments, the controller is configured to determine voiding target information based on historical data.

In some embodiments, the controller is configured to store the voiding target location data, including any weighting factor data, for further processing according to desired controller functions.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

We claim:

1. One or more wearable devices configured to be worn by an animal and operable to stimulate said animal, the one or more wearable devices together comprising:
a. an animal activity sensing device configured to sense animal activity data indicative of an initiation of, or an occurrence of, voiding by said animal;
b. at least one stimulus device operable to administer at least one form of stimulus to the animal; and
c. a controller configured to determine the initiation of, or an occurrence of, voiding based on the activity data, and in response, operate the at least one stimulus device to administer at least one form of stimulus to the animal.

2. The wearable device as claimed in claim 1, wherein the one or more wearable devices comprise a collar configured to be worn around the neck of said animal.

3. The wearable device as claimed in claim 2, wherein the one or more wearable devices further comprise a tail device configured to be worn proximal to, or on, said animal's tan, and to wirelessly communicate to the collar device, wherein the tail device comprises a tail controller and data transmission device, the tail controller configured to:
a. receive the animal activity data from the activity sensing device; and
b. operate the data transmission device to send the animal activity data to the collar device.

4. The one or more wearable devices as claimed in claim 1, wherein the activity sensing device comprises at least one of:
an inertial measurement unit,
an accelerometer,
a device configured to determine animal orientation, and
a device configured to determine movement.

5. The one or more wearable devices as claimed in claim 1, where the controller is configured to
a. determine the initiation, or occurrence, of voiding by said animal, and in response;
b. determine animal orientation based on animal activity data sensed by the activity sensing device;
c. operate the at least one stimulus device to thereby apply a moving stimulus to one ear of the animal to thereby encourage the animal to re-orient; and
d. continue to operate the at least one stimulus device to thereby apply said moving stimulus until the controller has determined the animal has re-oriented.

6. The one or more wearable devices as claimed in claim 5, wherein the controller is configured to:
determine the initiation of or occurrence of voiding by said animal, and in response,
operate the at least one stimulus device to thereby apply the moving stimulus to the animal to thereby encourage the animal to move, turn, or re-orient in order to increase the void area.

7. The one or more wearable devices as claimed in claim 1, wherein the wearable device further comprises a position sensing device configured to determine a location of said animal.

8. The one or more wearable devices as claimed in claim 7, wherein the controller is configured to receive a list of predetermined target locations appropriate for the animal to void.

9. The one or more wearable devices as claimed in claim 8, wherein the controller is further configured to
a. determine if the animal is not initiating voiding or voiding; and
b. determine if the location of said animal matches a predetermined target location, and if so:
c. operate the at least one stimulus device to apply a cueing stimulus to the animal.

10. The one or more wearable device as claimed in claim 8, wherein the controller is further configured to
a. determine the animal is initiating voiding or voiding based on the animal activity data sensed from the activity sensing device;
b. determine if the location of said animal is at the predetermined target location; and if so
c. operate the at least one stimulus device to apply a training stimulus to the animal.

11. The one or more wearable devices as claimed in claim 10, wherein the cueing stimulus and training stimulus are the same or substantially the same stimulus.

12. The one or more wearable devices as claimed in claim 8, wherein the target location is one or more selected from:
a. a location comprising nitrogen or other chemically deficient areas;
b. a location comprising carbon-rich soil;
c. a location comprising a preferred soil macro-porosity;
d. an environmentally friendlier location than the animal's current location;
e. a location which is higher than the current location, or of a minimum height;
f. a location comprising lower quality pasture;
g. a location comprising an effluent catchment area or like location;
h, a milking shed, yard, or part thereof;
i. a stand-off pad; and
j. a urine collection area.

13. A method for controlling void locations of an animal, wherein the method comprises:
a. attaching a wearable device to said animal, the device comprising:
i. an animal activity sensing device configured to sense animal activity data;
ii. at least one stimulus device operable to administer at least one form of stimulus to the animal; and
iii. a controller configured to receive animal activity data and control the at least one stimulus device;
b. determining, with the controller, the initiation of or occurrence of voiding based on the animal activity data; and
c. controlling the at least one stimulus device to apply a stimulus to the animal to either
i. encourage the animal to turn or re-orient whilst voiding, or
ii train the animal to void when said stimulus is applied.

14. The method as claimed in claim 13, wherein the wearable device comprises a position sensing device configured to determine the location of said animal.

15. The method as claimed in claim 14, wherein the method further comprises the controller configured for:
a. determining location of said animal via the position sensing device;
b. determining if location of said animal matches a target location, where the target location is a predetermined location designated appropriate for the animal to void;
c. determining initiation of or occurrence of voiding based on the animal activity data; and
d. operating the at least one stimulus device to apply
i. a moving stimulus if the controller determines the location is not in or at a target location to encourage the animal to turn or re-orient whilst voiding, or
ii. a training stimulus if the controller determines animal location is not in or at a target location to condition the animal to void.

16. The method as claimed in claim 14, wherein the method further comprises:
a. determining location of said animal via the position sensing device;
b. determining if location of said animal is in or at a target location, where the target location is a location which has been designated appropriate for the animal to void;
c. determining if the activity sensing device does not detect initiation of or occurrence of voiding; and
d. applying a cueing stimulus if the animal location is in a target location, where the cueing stimulus encourages the animal to void based on prior training with the training stimulus.

17. The method as claimed in claim 13, wherein the animal is a cow which urinates from near its tail, and re-orientating the cow moves the head of the cow around, and therefore the tail end of the cow around also, to distribute urine during voiding.

18. An animal guidance system operable to guide the animal to an untrained target location for the animal to void at, the system comprising:
a. a wearable apparatus adapted to be worn by the animal, the apparatus comprising at least one stimulus device operable to administer at least one form of stimulus to the animal and to guide the animal to the target location;
b. at least one position sensing device configured to output animal position data;
c. at least one animal activity sensing device configured to output activity data relating to activity of the animal; and
d. at least one controller configured to:
i. receive the animal position data;
ii. receive the activity data;
iii. determine voiding information from the animal position data and/or activity data; and
iv. operate the at least one stimulus device to administer the stimulus to guide the animal to the target location based on the determined voiding information, and further configured to continue to operate the stimulus device to continue to guide the animal until the animal has reached the target location.

19. The animal guidance system as claimed in claim 18, wherein the controller is further configured to operate the at least one stimulus device to administer the stimulus to guide the animal, based on the determined voiding information, to the target location only when the controller determines the voiding information indicates voiding is imminent, commencing, or occurring.

20. The animal guidance system as claimed in claim 18, wherein the controller is further configured to,
a. determine location of said animal via the at least one position sensing device;
b. determine if location of said animal matches the target location, where the target location is a location which has been designated appropriate for the animal to void;
c. determine if the at least one activity sensing device does not detect initiation of or occurrence of voiding,
d. apply a cueing stimulus if the animal location is in the target location, wherein the animal has been trained to void upon receiving the cueing stimulus.
